(19) United States
(12) Patent Application Publication
(10) Pub. No.: US 2006/0286518 A1
(43) Pub. Date: Dec. 21, 2006

(54) Product environmental information system

(76) Inventor: Thomas N. Yoder, Presque Isle, ME (US)

Correspondence Address: ANTOINETTE M. TEASE, P. O. BOX 51016, BILLINGS, MT, 59105, US

(21) Appl. No.: 10/951,139

(22) Filed: Sep. 27, 2004

(51) Int. Cl. G09B 19/00

(52) U.S. Cl. 434/236

(57) ABSTRACT

A system and method for calculating and communicating personalized product environmental information to users at the point of purchase, for accounting for pollution resulting from raw material production, manufacture, use disposal and packaging of the purchased product and for accounting for price surcharges paid by the purchaser. In a preferred embodiment, the user can scan a Universal Product Code on a product label using a handheld computer with a bar code reader and view personalized product information and ratings on the handheld computer. In another preferred embodiment, the information can be viewed on a desktop computer when purchasing online over a network. Preferably, individual pollution and price surcharge accounts are maintained for each user based on purchases, allowing for price surcharges and non-profit donations to be collected based on product lifecycle pollution quantities.

A portion of the disclosure of this patent document contains material which is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates to a system and method for managing personalized information regarding a product. In particular, the invention relates to a computer-implemented system and method for calculating and communicating personalized product environmental information to a user, for accounting for pollution resulting from raw material production, manufacture, use disposal and packaging of the purchased product and for accounting for price surcharges paid by the purchaser.

The background art is characterized by U.S. Pat. Nos. 4,780,599; 5,478,989; 5,699,525; 5,960,402; 6,375,077; and 6,581,829; and U.S. Patent Application Nos. 2003/0059106; 2002/0084328; 2003/0034391; 2003/0069745; 2003/0097310; and 2003/0158796; the disclosures of which patents and patent applications are incorporated by reference as if fully set forth herein.

Baus in U.S. Pat. No. 4,780,599 discloses an apparatus for storing and releasing information that incorporates a reading device for scanning bar codes on saleable goods. The apparatus offers to user, in department stores or the like, specific information concerning products to be sold. This invention is limited in that structures and steps are not provided for performing calculations and managing other than static information. Moreover, no impact or surcharge accounting features are envisioned.

Shepley in U.S. Pat. No. 5,478,989 discloses a method for providing personalized nutritional information to shoppers. This invention is limited in that it is limited to nutritional information and does not provide the structures and steps required to manage environmental information. Moreover, no impact or surcharge accounting features are envisioned.

Embutsu et al. in U.S. Pat. Nos. 5,699,525 and 5,960,402 disclose information management systems for dealing with waste in a waste recycling system. These inventions are limited in that they do not solve the problems addressed by the invention disclosed herein.

Hankins in U.S. Pat. No. 6,375,077 discloses a system for advising a user when selecting a product. This invention is limited in that it is structured to simply advise a user whether or not to buy a product and does not provide the structures and steps required to manage environmental impact information. Moreover, only information related to products matching user preferences is managed for mobile users, and no impact or surcharge accounting features are envisioned.

Kim in U.S. Pat. No. 6,581,829 (and U.S. Patent Application No. 2002/0084328 discloses a method for discriminating the production background of a product by means of a bar code system. This invention is limited in that it requires that special bar codes (ES codes or environmental protection and safety codes) be marked on products.

Tani in U.S. Patent Application No. 2002/0059106 discloses a system for supplying recyclable consumable goods. This invention is limited in that it does not solve the problems addressed by the invention disclosed herein.

Wagner et al. in U.S. Patent Application No. 2003/0034391 discloses a method and system for disposing of discarded items. This invention is limited in that it does not solve the problems addressed by the invention disclosed herein.

Zenko in U.S. Patent Application No. 2003/0069745 discloses a waste collection system and method. This invention is limited in that it does not solve the problems addressed by the invention disclosed herein.

Ono et al. in U.S. Patent Application No. 2003/0097310 disclose a management control method for collection of expendables, such as toner cartridges. This invention is limited in that it does not solve the problems addressed by the invention disclosed herein.

Balent in U.S. Patent Application No. 2003/0158796 discloses a distributed personal automation and shopping method. This invention is limited in that it does not solve the problems addressed by the invention disclosed herein.

What is needed is a system and method for managing information (e.g., environmental information) about products. None of the background art discloses a computer-implemented system for calculating and communicating personalized product environmental information to consumers and businesses (users) at the point of purchase, for accounting for pollution resulting from raw material production, manufacture, use disposal and packaging of the purchased product or service and for accounting for price surcharges paid by the purchaser.

### BRIEF SUMMARY OF THE INVENTION

The purpose of the invention is to manage environmental information about products. Advantages of preferred embodiments of the invention are that they offer a strong value proposition to businesses that are implementing environmentally preferable purchasing programs, to green consumers who want to make a difference through their actions, and to environmental non-profit organizations that are looking for new ways to better serve their supporters and fulfill their missions.

One object of preferred embodiments of the invention is to create a new fundraising mechanism for environmental non-profit organizations involving surcharges. Another object of preferred embodiments of the invention is to make the surcharges tax-deductible contributions for consumer and business users. Another object of preferred embodiments of the invention is to internalize the societal costs of pollution in the market prices of products.

In a preferred embodiment, the invention involves the use of Universal Product Codes (UPC) and a computerized system to calculate and communicate personalized product environmental information to consumers and businesses (users) at the point of purchase, and to account for pollution resulting from use of the purchased product or service. In a preferred embodiment, the user can scan a UPC product label using a handheld computer with a bar code reader and view personalized product information and ratings on the handheld computer. In another preferred embodiment, the information can be viewed on a desktop computer when purchasing online over a network. Preferably, individual pollution and price surcharge accounts are maintained for each user based on purchases, allowing for price surcharges and non-profit donations to be collected based on product lifecycle pollution quantities. The system can also be implemented on smart cards, a portable shopping system or other platforms.

In a preferred embodiment, the system provides environmental information on consumer food and household products and utilities—those products typically purchased at grocery stores and hardware/home improvement stores—and on services purchased from utilities. For businesses, office and building supplies are included in the system. In an alternative embodiment, information is provided on other consumer and business product lines.

In a preferred embodiment, when a user registers with the system, the user enters information on the user's use behavior and disposal behavior, plus information on the user's buying decision criteria, to produce a personalized profile. This behavioral information is used to personalize the user's pollution accounting algorithms, and the buying decision criteria are used to produce product ratings based on what is important to the user. In an alternative embodiment, default behavior information is used by the system.

Personalized product information and ratings (as opposed to the default behavior information) are a preferred aspect of the preferred embodiments of the invention. Preferably, each UPC can be used at the point of purchase to access specific pollution information based on the user's product use behavior and product disposal behavior, as well as a rating system based on the user's personal preferences. In alternative embodiments of the invention, the system is extended to suggest alternative products to the user based on the user's preferences and the user's selections at the point of purchase. While currently preferred embodiments of the invention focus on product environmental information, in other embodiments, the personalized information is extended to include other information categories and societal impacts, such as product safety, social responsibility and amount of local content.

In a preferred embodiment, the invention (preferably named the IPAS™ Network) keeps track of total pollutants, by pollutant, from purchases of in-network products for each user. This accounting system allows each user to track the user's progress in reducing the user's impact on the environment through the user's purchases.

In a preferred embodiment of the invention, users who participate in the system pay a price surcharge on polluting products. The surcharge preferably serves to internalize the societal cost of pollution in the product price, thus making green items relatively less expensive to the user than items that have higher levels of pollution over the product's lifecycle. In alternative embodiments, the user is an individual, a household, a company or another organization.

In another preferred embodiment, the invention is a service that is marketed through environmental nonprofit organizations by means of an affinity channel pricing structure that provides a new source of donations for public goods. The surcharge collected from each organization's members is preferably donated to these organizations. This structure creates a new fundraising mechanism for environmental nonprofit organizations and, at the same time, makes the surcharge a tax-deductible contribution for consumer and business users.

The hardware and software language platforms for preferred embodiments of this invention are commercially available. They include personal digital assistants and handheld computers, smart shopping systems, smartcards, bar code scanners, wireless networks, modems, memory chips, network servers, database software, and programming languages for developing the user interface.

In a preferred embodiment, the invention comprises three technical components: (1) a personalized product environmental information component, (2) a user-specific pollution and surcharge accounting system component, and (3) a user interface software application component. In a preferred embodiment of the personalized product environmental information component, user behavior, user preferences and product lifecycle assessment environmental data are used to calculate personalized information and ratings about products that the user is considering purchasing. This component preferably comprises the elements of a mathematical model, with variables contained in data vectors (vectors) and parameters and a functional form specified in formula (algorithms). In a preferred embodiment, this component makes use of a user preference vector, a user behavioral vector, a product pollution vector, an algorithm to compute personalized product pollution amounts based on the user behavioral vector, and an algorithm to compute a product rating and a price surcharge based on the user's preferences for avoiding the production of different pollutants.

In a preferred embodiment of the user-specific pollution accounting system component, the user registers purchases of products online (if shopping over a computerized network) or on the user's handheld computer or other device (which is then synchronized with a web server that updates the amount of each pollutant associated with each product the user purchases). In this embodiment, a price surcharge is added to the user's balance due, based on an algorithm that uses the user's personalized product pollutant vector and the user's preference vector. In this embodiment, the system keeps track of and reports to the user the amounts of each pollutant associated with products purchased by the user, as well as the surcharge balance due. The user is preferably billed monthly for the surcharge balance due. In this way, the accounting system internalizes the societal costs of pollution in the market price of the product.

In a preferred embodiment of the user interface software application component, users may interface with handheld computers or other devices during shopping trips to view information and record purchases. Users may also interface with network web pages to shop, enter and edit their preferences and behavior, view their account balances, and upload and download information from and to their handheld computers or other devices.

In a preferred embodiment, the invention is a computer-implemented method for managing personalized environmental information for a user regarding a product, said method comprising: collecting a plurality of pollution impact data from a lifecycle assessment of the product and associating the pollution impact data with a product identifier assigned to the product; parsing the pollution impact data and storing the parsed pollution impact data in a product pollution vector using default assumptions about use behavior and disposal behavior; storing portions of the pollution impact data to be used in calculating use impacts and disposal impacts in a use vector and a disposal vector, respectively; collecting information on the emissions of the fuel mix used to generate electricity consumed by products and services during use by the user and storing it in a use behavior vector; collecting information on the recycling and reuse of the byproduct streams of the user and the emissions of disposed byproduct streams and storing it in a disposal behavior vector; and calculating personalized product pollutant quantities using as inputs said product pollution vector, said use vector, said disposal vector, said use behavior vector, said disposal behavior vector and storing said personalized product pollutant quantities in a personalized product pollutant vector.

Preferably, the method further comprises: collecting information on the environmental impact preferences of the user and storing it in a user preference vector; calculating a product rating score for the product using as inputs said personalized product pollutant vector and said user preference vector and storing the result in a personalized product rating vector; and calculating a cumulative impact value for the product for each impact class and storing the result in the personalized product rating vector. Preferably, the method further comprises: collecting information on monetized societal impact of environmental impacts and storing the information in a social impact vector; and calculating a price surcharge for the product using said personalized product pollutant vector and said social impact vector as inputs and storing the result as a personalized price surcharge vector. Preferably, the method further comprises: transmitting the data contained in said personalized product rating vector and said price surcharge vector to the user's computer device via a network connection or a storage medium for display to the user. Preferably, the method further comprises: collecting a designation of a non-profit organization or a marketing channel partner from the user and storing it; and donating the price surcharge for the product indicated by said price surcharge vector, minus an administrative fee, to the user-designated non-profit organization or marketing channel partner. Preferably, the method further comprises: updating a pollution account of the user by adding said personalized product pollutant quantities to a first total in a pollutant account vector; and updating the surcharge account of the user by adding said price surcharge to a second total in a surcharge account vector.

Preferably, the method further comprises: transmitting the contents of a purchase transaction vector from a mobile computing device to a provider network server before performing the updating steps; transmitting the contents of said pollutant account vector and said surcharge vector from said provider network server to said mobile computing device; updating said pollutant account vector and said surcharge account vector to produce an updated pollutant account vector and an updated surcharge account vector; and resetting said purchase transaction vector in the mobile computing device. Preferably, the method further comprises: transmitting the contents of a purchase transaction vector from a shopping server to a provider network server before performing the updating steps; if the user has a mobile computing device, transmitting the contents of said pollutant account vector and said surcharge vector from said provider network server to said mobile computing device; updating said pollutant account vector and said surcharge account vector to produce an updated pollutant account vector and an updated surcharge account vector; and, if the user has said mobile computing device, placing said updated pollutant account vector and the updated surcharge account vector in a synchronization queue for transmission to said mobile computing device. Preferably, the method further comprises: transferring an amount in said updated surcharge account vector to an accounts receivable accounting system; sending a statement to the user; and accepting a payment from the user. Preferably, the method further comprises: calculating a payment amount to said user-designated non-profit organization or marketing channel partner; and transmitting said payment amount to said user-designated non-profit organization or marketing channel partner.

In another preferred embodiment, the invention is a computer-implemented method for calculating and communicating personalized product environmental information to a user, and for accounting for pollution resulting from purchasing a product, said method comprising: scanning a barcode on the product using a mobile, offline computing device; identifying the product; searching a database for a product rating vector and a price surcharge vector that are associated with the product; displaying to the user personalized product impact information, a personalized product rating and a personalized price surcharge that are associated with the product; accepting an indication that the product has been purchased; and appending a product purchase line to a purchase transaction vector.

In yet another preferred embodiment, the invention is a computer-implemented method for calculating and communicating personalized product environmental information to a user at a point of purchase, and for accounting for pollution resulting from purchasing a product, said method comprising: selecting the product and transmitting the selection to a server; searching a database for a personalized product pollutant vector, a product rating vector and a price surcharge vector that are associated with the product; displaying to the user personalized product impact information, a personalized product rating and a personalized price surcharge that are associated with the product; transmitting an indication to said server that the product has been purchased; appending a product purchase line to a purchase transaction vector; and transmitting the contents of said purchase transaction vector to said server.

In another preferred embodiment, the invention is a computer-implemented method for calculating and communicating personalized product environmental information to a user at a point of purchase of each of a plurality of products, and for accounting for pollution resulting from purchasing each product, said method comprising: accepting life cycle pollution data and a product code for each product; accepting registration data from the user; creating a pollutant account vector and a surcharge account vector for the user; accepting preference data and behavior data from the user and storing said data in a preference vector and a behavior vector; calculating personalized product pollutant quantities for the user for each product and storing said quantities in a personalized product pollutant vector; calculating a personalized product rating and a personalized price surcharge for the user for each product and storing them in a personalized product rating vector and a personalized price surcharge vector; placing said personalized product rating vector and said personalized price surcharge vector and/or software updates in a synchronization queue in a server; connecting the user's computing device with said server and storing said personalized product rating vector and said personalized price surcharge vector and/or software updates on said computing device; inputting an indication of the user's interest in a particular product to said computing device; displaying personalized product environmental information relating to said particular product to the user by means of said computing device; inputting a decision by the user to purchase said particular product to said computing device; transmitting said decision to said server; updating a pollutant account vector and a surcharge account vector of the user; charging the user a surcharge amount associated with the purchase of said particular product; and paying at least a portion of the surcharge amount to a selected non-profit organization.

In a further preferred embodiment, the invention is a computer-implemented system for managing personalized environmental information for a user regarding a product, said system comprising: means for collecting a plurality of pollution impact data from a lifecycle assessment of the product and associating the pollution impact data with a product identifier assigned to the product; means for parsing said pollution impact data and storing parsed pollution impact data in a product pollution vector; means for storing a portion of said pollution impact data to be used in calculating use impacts and disposal impacts in a use vector and a disposal vector, respectively;

means for collecting information on the emissions of the fuel mix used to generate electricity consumed by products and services during use by the user and storing it in a use behavior vector; means for collecting information on the recycling and reuse of the byproduct streams of the user and the emissions of disposed byproduct streams and storing it in a disposal behavior vector; and means for calculating personalized product pollutant quantities using as inputs said product pollutant vector, said use vector, said disposal vector, said use behavior vector, said disposal behavior vector and means for storing said personalized product pollutant quantities in a personalized product pollutant vector. Preferably, the system further comprises: means for collecting information on the environmental impact preferences of the user and storing it in a user preference vector; means for calculating a product rating score for the product using as inputs said personalized product pollutant vector and said user preference vector and storing the result in a personalized product rating vector; and means for calculating a cumulative impact value for the product for each impact class and storing the result in said personalized product rating vector. Preferably, the system further comprises: means for collecting information on monetized societal impact of environmental impacts and storing the information in a social impact vector; and means for calculating a price surcharge for the product using said personalized product pollutant vector and said social impact vector as inputs and storing the result as a personalized price surcharge vector. Preferably, the system further comprises: means for transmitting the data contained in said personalized product rating vector and said price surcharge vector to the user's computer device via a network connection or a storage medium for display to the user.

Preferably, the system further comprises: means for collecting a designation of a non-profit organization or a marketing channel partner from the user and storing it; means for donating the price surcharge indicated by said price surcharge vector, minus an administrative fee, to the user-designated non-profit organization or marketing channel partner. Preferably, the system further comprises: means for updating a pollution account of the user by adding said personalized product pollutant quantities to a first total in a pollutant account vector; and means for updating a surcharge account of the user by adding said price surcharge to a second total in a surcharge account vector. Preferably, the system further comprises: means for transmitting the contents of a purchase transaction vector from a mobile computing device to a provider network server; and means for transmitting the contents of said pollutant account vector and said surcharge vector from said provider network server to said mobile computing device; means for updating said pollutant account vector and said surcharge account vector to produce an updated pollutant account vector and an updated surcharge account vector; and means for resetting said purchase transaction vector in said mobile computing device.

Preferably, the system further comprises: means for transmitting the contents of a purchase transaction vector from a shopping server to a provider network server; means for transmitting the contents of said pollutant account vector and said surcharge vector from said provider network server to said mobile computing device; and means for updating said pollutant account vector and said surcharge account vector to produce an updated pollutant account vector and an updated surcharge account vector; and means for placing said updated pollutant account vector and said updated surcharge account vector in a synchronization queue for transmission to a mobile computing device, if the user has such a device. Preferably, the system further comprises: means for transferring an amount in said updated surcharge account vector to an accounts receivable accounting system; means for sending a statement to the user; and means for accepting a payment from the user. Preferably, the further comprises: means for calculating a payment amount to said user-designated non-profit organization or marketing channel partner; and means for transmitting said payment amount to said user-designated non-profit organization or marketing channel partner.

In yet another preferred embodiment, the invention is a computer-implemented system for calculating and communicating personalized product environmental information to a user, and for accounting for pollution resulting from purchasing a product, said method comprising: means for scanning a barcode on the product using a mobile, offline computing device; means for identifying the product; means for searching a database for a product rating vector and a price surcharge vector that are associated with the product; means for displaying to the user personalized product impact information, a personalized product rating and a personalized price surcharge that are associated with the product; means for accepting an indication that the product has been purchased; and means for appending a product purchase line to a purchase transaction vector.

In a further preferred embodiment, the invention is a computer-implemented system for calculating and communicating personalized product environmental information to a user at a point of purchase, and for accounting for pollution resulting from purchasing a product, said system comprising: means for selecting the product and for transmitting the selection to a server; means for searching a database for personalized product pollutant vector, a personalized product rating vector and a personalized price surcharge vector that are associated with the product; means for displaying to the user personalized product impact information, a personalized product rating and a personalized price surcharge that are associated with the product; means for transmitting an indication to the server that the product has been purchased; means for appending a product purchase line to a purchase transaction vector; and means for transmitting the contents of said purchase transaction vector to the server.

In another preferred embodiment, the invention is a computer implemented system for calculating and communicating personalized product environmental information to a user at a point of purchase of each of a plurality of products, and for accounting for pollution resulting from purchasing each product, said system comprising: means for accepting life cycle pollution data and a product code for each product; means for accepting registration data from the user; means for creating a pollutant account vector and a surcharge account vector for the user; means for accepting preference data and behavior data from the user and storing said data in a preference vector and a behavior vector; means for calculating personalized product pollutant quantities for the user for each product and storing said quantities in a personalized product pollutant vector; means for calculating a personalized product rating and a personalized price surcharge for the user for each product and storing them in a personalized product rating vector and a personalized price surcharge vector; means for placing said personalized product rating vector and said personalized price surcharge vector and/or software updates in a synchronization queue in a server; means for connecting the user's computing device with said server and storing said personalized product rating vector and said personalized price surcharge vector and/or software updates on said computing device; means for inputting an indication of the user's interest in a particular product to said computing device; means for displaying personalized product environmental information to the user by means of said computing device; means for inputting a decision by the user to purchase said particular product to said computing device; means for transmitting said decision to said server; means for updating a pollutant account vector and a surcharge account vector of the user; means for charging the user a surcharge amount associated with the purchase of the particular product; and means for paying at least a portion of the surcharge amount to a selected non-profit organization.

In another preferred embodiment, the invention is a computer implemented method for calculating and communicating personalized product environmental information to a user, and for accounting for pollution resulting from purchasing a product, said method comprising: a step for scanning a barcode on the product using a mobile, offline computing device; a step for identifying the product; a step for searching a database for a product rating vector and a price surcharge vector that are associated with the product; a step for displaying to the user personalized product impact information, a product rating and a price surcharge that are associated with the product; a step for accepting an indication that the product has been purchased; and a step for appending a product purchase line to a purchase transaction vector.

In yet another preferred embodiment, the invention is a computer-implemented method for calculating and communicating personalized product environmental information to a user at a point of purchase, and for accounting for pollution resulting from purchasing a product, said method comprising: a step for selecting the product and transmitting the selection to a server; a step for searching a database for a personalized product pollutant vector, a product rating vector and a price surcharge vector that are associated with the product; a step for displaying to the user personalized product impact information, a product rating and a price surcharge that are associated with the product; a step for transmitting an indication to the server that the product has been purchased; a step for appending a product purchase line to a purchase transaction vector; and a step for transmitting the contents of the purchase transaction vector to the server.

In another preferred embodiment, the invention is a computer-implemented method for calculating and communicating personalized product environmental information to a user at a point of purchase of each of a plurality of products, and for accounting for pollution resulting from each purchased product, said method comprising: a step for accepting life cycle pollution data and a product code for each product; a step for accepting registration data from the user; a step for creating a pollutant account vector and a surcharge account vector for the user; a step for accepting preference data and behavior data from the user and storing said data in a preference vector and a behavior vector; a step for calculating personalized product pollutant quantities for the user for each product and storing said quantities in a personalized product pollutant vector; a step for calculating a personalized product rating and a personalized price surcharge for the user for each product and storing them in a personalized product rating vector and a personalized price surcharge vector; a step for placing said personalized product rating vector and said personalized price surcharge vector and/or software updates in a synchronization queue in a server; a step for connecting a user's computing device with said server and storing said personalized product rating vector and said personalized price surcharge vector and/or software updates on said computing device; a step for inputting an indication of the user's interest in a particular product to said computing device; a step for displaying personalized product environmental information relating to said particular product to the user by means of said computing device; a step for inputting a decision by the user to purchase said particular product to said computing device; a step for transmitting said decision to said server; a step for updating a pollutant account vector and a surcharge account vector of the user; a step for charging the user a surcharge amount associated with the purchase of the particular product; and a step for paying at least a portion of the surcharge amount to a selected non-profit organization.

In another preferred embodiment, the invention is an apparatus for storing and retrieving information associated with various coded items, said apparatus comprising: a reading device for reading codings associated with individual items to produce coding signals; a storage unit for storing societal impact information associated with individual items at respective storage addresses, each address being accessible through a corresponding address signal; a first data processing unit for receiving coding signals read by said reading device and transmitting address signals to said storage unit to retrieve stored societal impact information from the corresponding storage addresses, wherein said first data processing unit comprises a coding unit which in response to receipt of at least one coding signal produces an associated address signal for transmission to said storage unit; a second data processing unit for calculating personalized product ratings and personalized price surcharges and for accounting for cumulative societal impacts and cumulative price surcharges associated with the purchase of selected individual items by a user of the apparatus; and an output unit for making retrieved societal impact information, personalized product ratings, personalized price surcharges, cumulative societal impacts and cumulative price surcharges available to the user of the apparatus.

In a further preferred embodiment, the invention is a process for storing and retrieving information associated with various coded items, said process comprising: reading codings associated with individual items with a reading device to produce coding signals; storing societal impact information associated with individual items at respective storage addresses in a storage unit, each address being accessible through a corresponding address signal; receiving coding signals read by said reading device at a first data processing unit and transmitting address signals to said storage unit to retrieve stored societal impact information from the corresponding storage addresses; calculating personalized product ratings and personalized price surcharges and accounting for cumulative societal impacts and cumulative price surcharges associated with the purchase of selected individual items by a user; and making retrieved societal impact information, personalized product ratings, personalized price surcharges, cumulative societal impacts and cumulative price surcharges available to the user.

In another preferred embodiment, the invention is an apparatus for generating personalized product information for an individual comprising: means for inputting personal data relating to the individual; means for calculating personalized product ratings and personalized price surcharges; means for accounting for cumulative societal impacts and cumulative price surcharges associated with the purchase of selected products by the individual; barcode means for inputting a code identifying at least one product that the individual is considering purchasing; processor means under the control of a computer program for associating said code with said personalized product ratings and said personalized price surcharges pertinent to said at least one product that the individual is considering purchasing; means for outputting said personalized product ratings and said personalized price surcharges to the individual pertinent to said at least one product identified by said code; and means for outputting information to the individual concerning said cumulative societal impacts and said cumulative price surcharges associated with purchasing said at least one product identified by said code.

In yet another preferred embodiment, the invention is a computer-implemented process for generating personalized product information for an individual comprising: inputting personal data relating to the individual; calculating personalized product ratings and personalized price surcharges; accounting for cumulative societal impacts and cumulative price surcharges associated with the purchase of selected products by the individual; inputting a code identifying at least one product that the individual is considering purchasing; associating the code with said personalized product ratings and said personalized price surcharges pertinent to said at least one product that the individual is considering purchasing; outputting said personalized product ratings and said personalized price surcharges to the individual pertinent to said at least one product identified by said code; and outputting information to the individual concerning said cumulative societal impacts and said cumulative price surcharges associated with purchasing said at least one product identified by said code.

In another preferred embodiment, the invention is a system for internalizing the societal cost of a product purchased by a user, said system comprising: a product database having personalized product ratings and personalized price surcharges corresponding to a plurality of products; means for selecting a particular product listed in said product database; means for displaying a personalized product rating and a personalized price surcharge associated with said particular product; and means for accounting for cumulative societal impacts and cumulative price surcharges associated with a purchase of said particular product by the user.

In yet another preferred embodiment, the invention is a technique for internalizing the societal cost of a product purchased by a user, said technique comprising: providing a product database having personalized product ratings and personalized price surcharges corresponding to a plurality of products; selecting a particular product listed in said product database; displaying a personalized product rating and a personalized price surcharge associated with said particular product; and accounting for cumulative societal impacts and cumulative price surcharges associated with a purchase of said particular product by the user.

In another preferred embodiment, the invention is a method for providing information to a consumer regarding environmental aspects relating to the production, use and disposal of a product, said method comprising: reading a bar code positioned on the product or its packaging; transmitting information contained in said bar code to a computer; evaluating a database of information based on the transmitted information contained in said bar code; receiving a personalized product rating and a personalized price surcharge related to the production, use and disposal of the product residing in said database of information, whereby the consumer can make an informed decision about whether to purchase the product; and, if the consumer purchases the product, accounting for cumulative societal impacts and cumulative price surcharges associated with a purchase of the product.

In another preferred embodiment, the invention is a system for providing information to a consumer regarding environmental aspects relating to the production and use and disposal of a product by a consumer, said system comprising: a bar code reader for reading a bar code; a processor for evaluating a database of information and providing a personalized product rating and a personalized price surcharge to the consumer related to the production, use and disposal of the product identified by said bar code, and for accounting for cumulative societal impacts and cumulative price surcharges associated with a purchase of the product identified by said bar code by the consumer.

In a further preferred embodiment, the invention is a system for providing information to a consumer regarding environmental aspects relating to the production and use and disposal of a product by a consumer, said system comprising: a input device for selecting the product; a processor for evaluating a database of information and providing a personalized product rating and a personalized price surcharge to the consumer related to the production, use and disposal of said selected product, and for accounting for cumulative societal impacts and cumulative price surcharges associated with a purchase of said selected product by the consumer.

In another preferred embodiment, the invention is a computer-readable medium having computer-executable instructions for performing a technique, method or process disclosed herein.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate presently preferred embodiments of the invention. In the drawings:

FIG. 1 is a schematic block diagram of a preferred embodiment of the invention.

FIG. 2 is a schematic flow diagram for the personalized product environmental information component, the user-specific pollution accounting system component, and the user interface software application component of a preferred embodiment of the invention.

FIG. 3 is a schematic flow diagram for the personalized product environmental information component, the user-specific pollution accounting system component, and the user interface software application component of another preferred embodiment of the invention.

FIG. 4 illustrates a preferred data structure for reporting product lifecycle pollution impacts.

FIG. 5 illustrates a preferred data structure for a product pollution data vector.

FIG. 6 illustrates a preferred data structure for a personalized product pollutant vector and preferred formulas for calculating impacts associated with each user-product combination in the system.

FIG. 7 illustrates a preferred data structure for a personalized product rating vector and preferred formulas for calculating a product rating score for each user-product combination in the system.

FIG. 8 illustrates a preferred data structure for a personalized price surcharge vector and preferred formulas for calculating a product price surcharge for each user-product combination in the system.

FIG. 9 illustrates a preferred data structure for a pollutant account vector and a preferred formula for calculating the pollutant account balance by impact class.

FIG. 10 illustrates a preferred data structure for a surcharge account vector and a preferred formula for calculating the surcharge account balance.

FIG. 11 is a schematic process flow diagram of a preferred embodiment of the account update process for mobile, offline shoppers.

FIG. 12 is a schematic process flow diagram of a preferred embodiment of the account update process for desktop, online shoppers.

FIG. 13 is a schematic process flow diagram of a preferred embodiment of the accounts receivable process for user surcharge accounts.

FIG. 14 is a schematic process flow diagram of a preferred embodiment of the accounts payable process for donation partners.

FIG. 15 is a schematic process flow diagram of a preferred embodiment of the process for mobile, offline purchasing.

FIG. 16 is a schematic process flow diagram of a preferred embodiment of the process for online purchasing.

The following reference numerals are used to indicate the parts and environment of the invention on the drawings:

10 system

12 server, network server

14 database

16 mobile computing device

18 personal computer

20 Internet, network

22 bar code reader

24 bar code, product identifier

26 product

30 process, service

32 analyze lifecycle pollution data step

34 sign up step

36 create new account pollution and surcharge vectors step

38 enter preferences and behavior step

40 create new behavior vector step

42 create new preferences vector step

44 calculate personalized product pollution quantities step

46 create personalized product pollutant vector step

50 calculate personalized product ratings and price surcharges step

52 create personalized product rating and price vector step

54 put personalized product and software updates in queue step

60 synchronize handheld to install software and personalized product data files

62 shop and scan product bar code step

64 view personalized product information step

66 purchase decision step

68 record product purchase quantity

70 continue decision step

72 synchronize handheld using Internet step

80 update user account pollution and surcharge vectors step

82 charge user credit card monthly step

84 issue credit to user surcharge vector and debit to non-profit partner step

86 put notice of new pollution and surcharge balances in queue step

90 reporting table

92 product pollution vector

110 personalized product pollutant vector

112 use column

114 disposal column

116 packaging column

120 personalized product rating vector

122 personalized price surcharge vector

130 pollutant account vector

132 surcharge account vector

140 connect to network step

142 initiate synchronization step

144 read data in purchase transaction vector step

146 update pollutant account and surcharge account vectors step

148 transmit account balances to mobile computing device step

150 overwrite purchase transaction vector step

158 place account balances in synchronization queue step

160 read balances in surcharge and pollutant account vectors step

162 determine whether automatic payment is authorized step

164 send statement step

166 send payment step

168 charge credit or debit card and send statement step

170 debit and credit user and donation partner accounts step

172 calculate payment amounts step

174 debit and credit donation partner and service provider accounts step

176 transmit funds to partner step

178 transmit excess subscription fees to partner step

180 scan barcode step

182 interpret bar code step

184 locate product information step

186 determine whether product is in system step

188 notify user that no information is available step

190 display personalized environmental information step

192 decide whether to purchase product step

194 indicate decision to purchase and quantity step

198 append line to purchase transaction vector step

200 start online shopping step

202 view product environmental information step

### DETAILED DESCRIPTION OF THE INVENTION

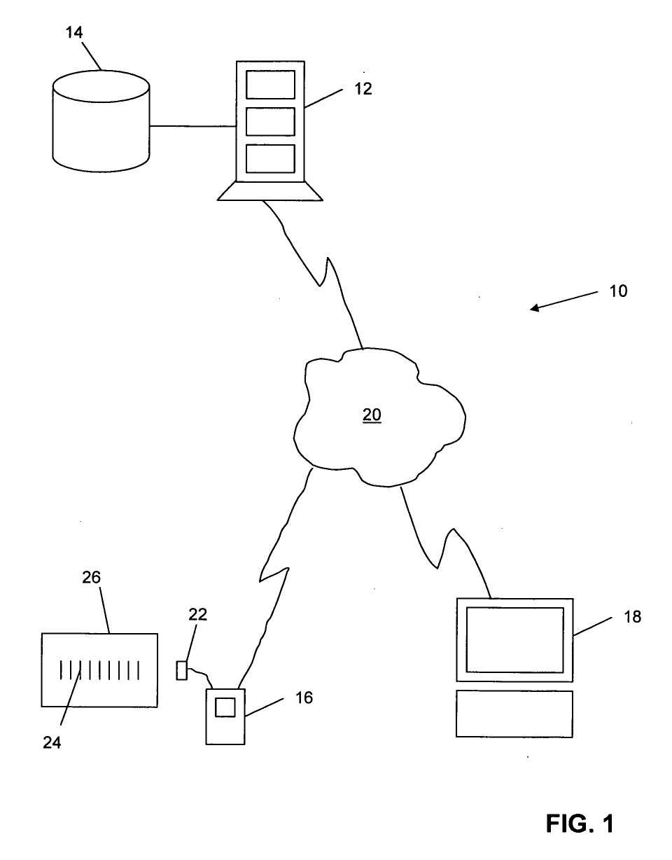

Referring to FIG. 1, a preferred embodiment of system 10 is presented. System 10 comprises server 12 which is connected to database 14, and mobile computing device 16 and/or personal computer 18 which are connected to server 12 via Internet or network 20. Preferably, mobile computing device 16 comprises or is attached to bar code reader 22 that reads bar code 24 on product 26. A variety of vectors are stored in database 14, mobile computing device 16 and/or personal computer 18. These vectors have any appropriate form (e.g., relational database tables or records, object database objects, extensible markup language files, etc.), but preferably contain the data structures disclosed herein.

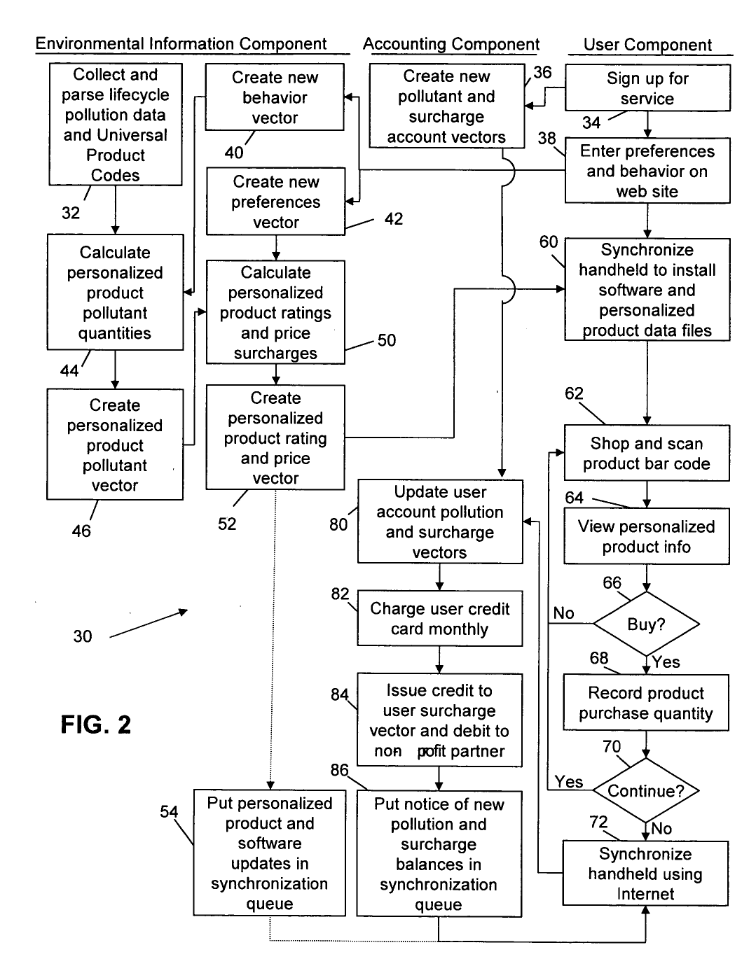

Referring to FIG. 2, a schematic process flow diagram of an embodiment of process (or service) 30 that is appropriate for a mobile, offline user is presented. In step 32, life cycle pollution data for each product 26 in system 10 having a Universal Product Code or other widely-used product code are collected and parsed.

In step 34, a user signs up for the services implemented by means of system 10. When the user is registered with system 10, new pollutant account and surcharge account vectors are created in step 36. The user then enters information about the user's preferences and behavior in step 38 and a new user behavior vector for the user is created in step 40 and a new user preference vector for the user is created in step 42.

In step 44, parsed lifecycle pollution data from step 32, behavior data from step 40 are used to calculate personalized product pollutant quantities for the user in step 44. These quantities are used to create a personalized product pollutant vector for each product-user combination in step 46.

Personalized product ratings and price surcharges for each product-user combination are calculated in step 50 using data in the personalized product pollutant vector from step 46 and the user preference vector from step 42. These personalized product ratings and price surcharges are used to create a personalized product rating vector and a personalized price surcharge vector for each product-user combination in step 52. Personalized product and software updates are placed in the synchronization queue in step 54. In step 60, mobile computing device 16 is synchronized with server 12 to install software and personalized product data files in step 60.

In step 62, during a shopping trip, the user uses scanner 22 to scan bar code 24 on product 26. Then, in step 64, personalized information about product 26 is displayed to and viewed by the user. In step 66, the user decides whether to buy product 26. If the decision is “No,” the user returns to step 62 or ceases shopping. If the decision is “Yes,” the product purchase quantity is recorded in step 68. At this point, the user decides whether to continue shopping in step 70. If the decision is “Yes,” the user returns to step 62.

If the answer is “No,” at the first opportunity, mobile computing device 16 is synchronized with server 12 via Internet 20 in step 72. In this case, user account and pollution vectors that were created in step 36 are updated in step 80. In step 82, the user's credit card is charged the cumulative total in the user's surcharge account, preferably on a monthly basis. The user's surcharge account is credited and the non-profit partner's account is debited in step 84. In step 86, a notice is placed in the synchronization queue of the existence of new pollution and surcharge balances. These balances and the personalized product and software updates from step 54 are transmitted to mobile computing device 16 in step 72.

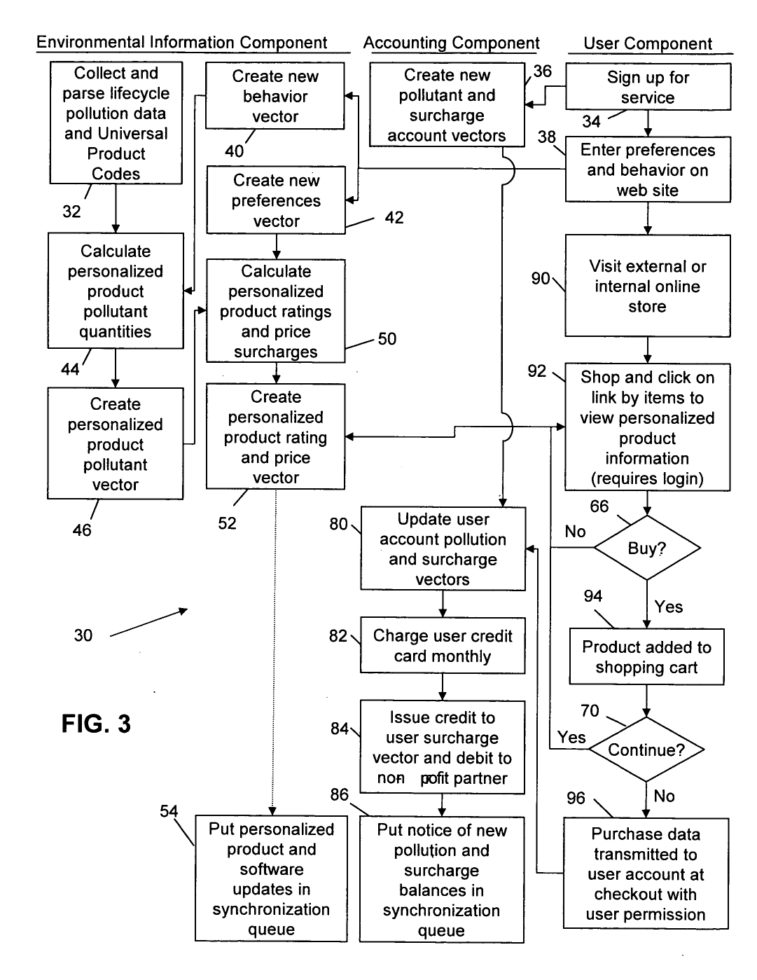

Referring to FIG. 3, a schematic flow diagram of an embodiment of process (or service) 30 that is appropriate for a desktop, online user is presented. In step 32, life cycle pollution data for each product 26 in system 10 having a Universal Product Code or other widely-used product code are collected and parsed.

In step 34, a user signs up for the services implemented by means of system 10. When the user is registered with system 10, new pollutant account and surcharge account vectors are created in step 36. The user then enters information about the user's preferences and behavior in step 38 and a new use behavior vector for the user is created in step 40 and a new user preference vector for the user is created in step 42.

In step 44, parsed lifecycle pollution data from step 32, behavior data from step 40 are used to calculate personalized product pollutant quantities for the user in step 44. These quantities are used to create a personalized product pollutant vector for each product-user combination in step 46.

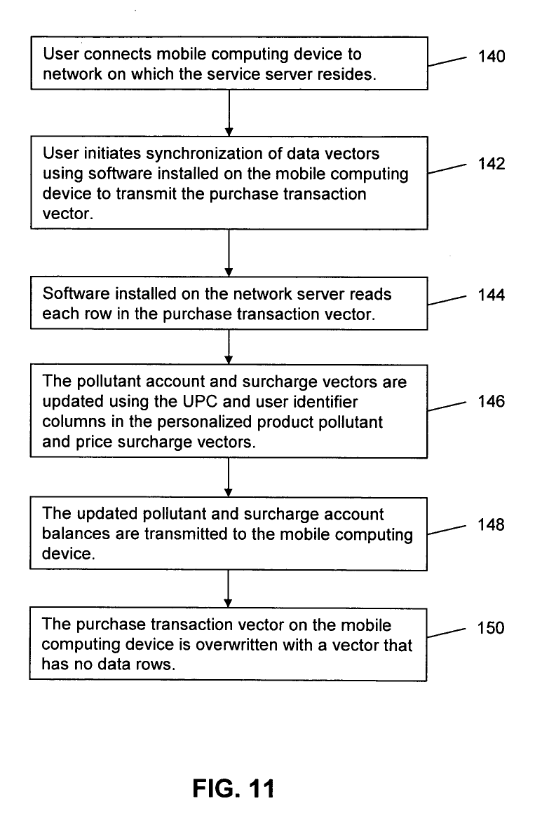

Personalized product ratings and price surcharges for each product-user combination are calculated in step 50 using data in the personalized product pollutant vector from step 46 and the user preference vector from step 42. These personalized product ratings and price surcharges are used to create a personalized product rating vector and a personalized price surcharge vector for each product-user combination in step 52. Personalized product and software updates are placed in the synchronization queue in step 54. These updates are transferred to mobile computing device 16 in accordance with the user initiated synchronization process described in FIG. 11.

In step 90, the user visits an online store that is external of internal to system 10 by means of personal computer 18 and Internet 20. While shopping at the online store, the user clicks on a link to view personalized information about product 26 in step 92, preferably after the user has logged in to system 10. In step 66, the user decides whether to buy product 26. If the decision is “No,” the user returns to step 92 or ceases shopping. If the decision is “Yes,” the product is added to a shopping cart in step 94. At his point, the user decides whether to continue shopping in step 70. If the decision is “Yes,” the user returns to step 92.

If the answer is “No,” purchase data is transmitted to the user's account in system 10 at checkout in step 96, preferably with the user's permission. In this case, user account and pollution vectors that were created in step 36 are updated in step 80. In step 82, the user's credit card is charged, preferably on a monthly basis. The user's surcharge vector is credited and the non-profit partner's account is debited in step 84. In step 86, a notice is placed in the synchronization queue of new pollution and surcharge balances. These balances are transferred to mobile computing device 16 in accordance with the user initiated synchronization process described in FIG. 11.

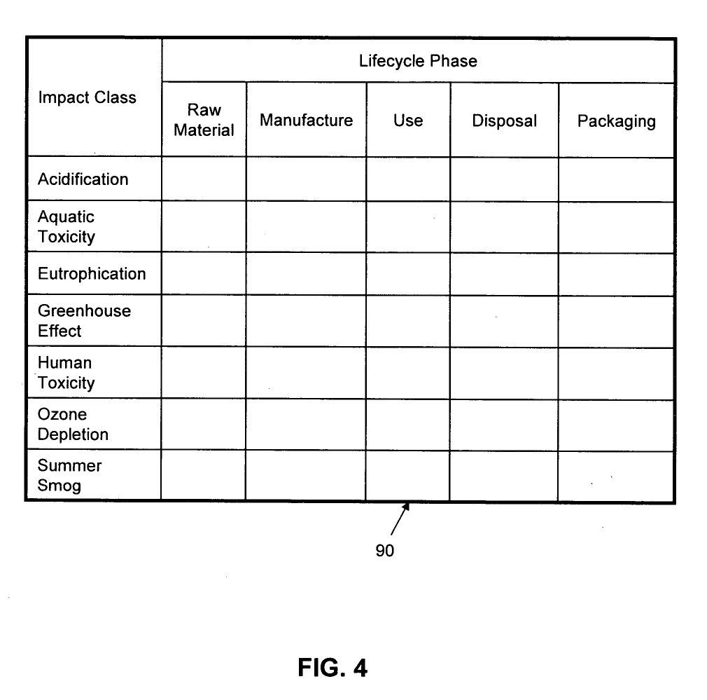

Preferred data structures used by the personalized environmental information component of the invention are illustrated in FIGS. 4-8. In this component of system 10, pollution impact data are collected from product lifecycle assessments performed by manufacturers or independent third parties. The process for performing these product lifecycle assessments conforms to the process set out by the International Organization for Standardization (ISO) in ISO 14040:1997, entitled Environmental management—Life cycle assessment—Principles and framework, which standard is incorporated by reference as if fully set forth herein and is available at a reasonable price from ISO Central Secretariat: International Organization for Standardization (ISO), 1 rue de Varembé, Case postale 56, CH-1211 Geneva 20, Switzerland.

Referring to FIG. 4, an example of a preferred structure for reporting table 90 (data structure) for reporting lifecycle pollution impacts for each product is illustrated. The values in the columns of the table represent the pollution amount for each lifecycle stage. The lifecycle stages are preferably defined as raw material, manufacture, use, disposal, and packaging and reflect the stages involved in the total lifecycle of the product. Preferably, the data are collected in either paper or electronic form. Raw inputs as well as final calculated values are preferably collected. For each product for which pollution data are collected, the Universal Product Code assigned to the product is also preferably collected.

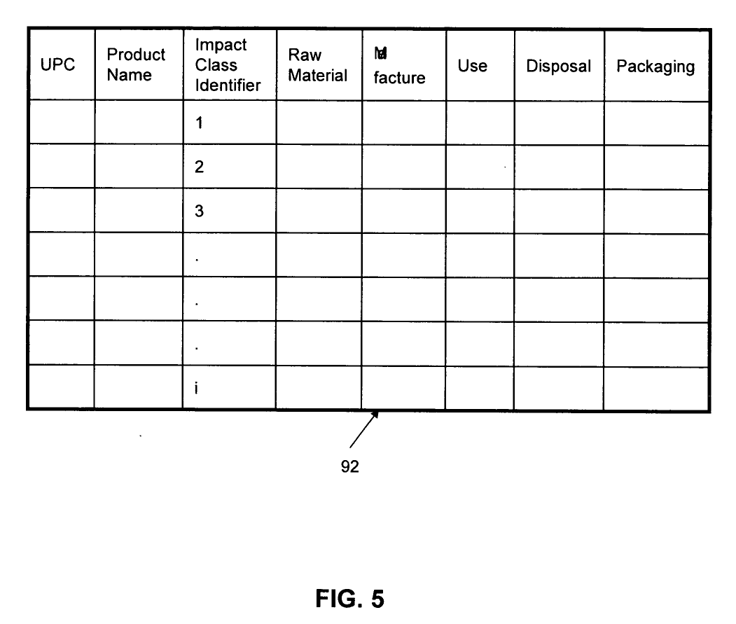

The pollution data resident in each reporting table 90 are parsed to conform the data to the impact classification definitions (impact classes) of a preferred embodiment of product pollution vector 92. A preferred data structure for product pollution vector 92 is illustrated in FIG. 5. Impact classification definitions include aquatic toxicity, human toxicity, ozone depletion, greenhouse effect, smog, acidification, eutrophication, and others, as appropriate. Environmental impact data for associated, non-energy products and services are parsed separately from the impact data for the product or service with which it is associated to avoid double-counting. For example, the environmental impacts of using a particular laundry detergent are accounted for separately from the impacts of using a washing machine. Thus, separable but associated accounting allows for reporting both by individual product or service and by a class of associated products and services.

Referring again to FIG. 5, impact data for each product are preferably stored in product pollution vector 92 of dimension (i,n+3) for each product or service in system 10, in which i is the number of rows that correspond to impact classifications, n is the number of columns that correspond to lifecycle phases, and the remaining three columns contain the UPC product code, the name of the product and the impact class identifier. Missing values are parsed and stored as a default value, preferably “'9.9.”

For determination of personalized environmental impacts from use and disposal, the raw data used in calculating impacts are preferably stored separately from the impact values calculated using default assumptions about use and disposal behavior about each product (or service). Raw data to be used in the calculation of personalized use and disposal pollution impacts for each product are preferably stored in a use vector (not shown) and a disposal vector (not shown), each of dimension (m,2). The use vector has m rows that correspond to the number of fuels and byproducts involved in use of the product, and two columns. The first column contains the resource identifier, such as name of fuel or byproduct, and the second column contains the amount of the resource used. These data are obtained from the product lifecycle assessments performed by the manufacturers of each product or independent third parties prepared in accordance with the ISO 14040 standard cited above. The m rows in the disposal vector correspond to the number of material types, such as aluminum, metal, and cardboard; the first column contains material type identifiers and the second column contains the amount of material disposed. These data are obtained from the product lifecycle assessments performed by the manufacturers of each product or independent third parties prepared in accordance with the ISO 14040 standard cited above. Missing values are passed and stored as a default value, preferably “−9.9.”

In a preferred embodiment, when the user signs up with system 10 (i.e., initiates or begins using the iPas™ Network service or process 30), information on the user's personal use behavior and disposal behavior is collected and stored in the environmental information component of system 10. Preferably, this personal information can be updated at any time by the user.

Personal use information includes the fuel mix used to produce the electricity consumed by each product (or service) during use and the users' behavior regarding recycling and reuse of byproduct streams that result from use of each product (or service). The user obtains the electricity fuel mix used to generate the electricity consumed by products the user purchases from the user's electricity supplier. Information on recycling and reuse of byproduct streams is derived from the user's knowledge of how the user recycles or reuses water, heat, solid waste and other byproduct streams. Preferably, parsed data are stored in the use behavior vector (not shown) of dimension (m,3), in which m is the number of rows that correspond to the number of fuels in the electricity mix and the number of byproduct streams that result from the use of each product (or service), and in three columns that contain an identifier of the fuel or byproduct stream in the first column, the behavior indicator value in the second column (which is the percentage of the resource that is reused or recycled), and an emissions value in the third column that is calculated using a fuels emission vector (not shown) that indicates type of fuel, emission type, emissions per unit. Missing values are parsed and stored as a default value, preferably “−9.9.” Values for populating the fuels emission vector are obtained from the U.S. Environmental Protection Agency, Washington, D.C. The personalized emissions per resource unit are calculated by first multiplying the resource quantities from the product lifecycle assessment times the behavior indicator value to obtain the personalized resource quantities, then multiplying these quantities times the emissions per resource unit from the fuels emissions vector.

Personal disposal information includes recycling and landfill information by type of material. Examples of material types include metal, aluminum, plastics, paper, cardboard, wastewater, and toxic materials. Parsed data are stored in a disposal behavior vector of dimension (m,3), where m is the number of rows that correspond to the number of material types, and three columns that correspond to the material type identifier in the first column, such as a material name, the disposal method indicator in the second column, and an emissions value in the third column that is calculated using a materials emission vector (not shown) that indicates type of material, emission type, and emissions per unit disposed. The disposal method indicator has discrete values for each possible type of disposal method, such as recycle, reuse, bury in landfill, and incinerate. Missing values are parsed and stored as a default value, preferably “−9.9.”

Information used to populate the materials emission vector is derived directly from the product lifecycle assessments described herein or from government and private sector research organizations, such as the U.S. National Institute on Standards and Technology in Gaithersburg, Maryland. The personalized emissions per material unit are calculated by multiplying the disposal material quantities from the product lifecycle assessment (in the disposal vector) times the material emissions per unit of material for the specific disposal method indicator for the user (in the disposal behavior vector). This personalized emissions value is then multiplied times the impact per emission unit to calculate the disposal impacts by impact class.

In a preferred embodiment, emissions associated with each particular product are personalized, but not the impact per emission unit. This embodiment uses the impact per emission unit data derived from the product lifecycle assessment obtained from the manufacturer or third party to populate the emission impacts vector. This per unit emission impact is multiplied times the personalized emissions estimate to obtain the personalized environmental impact of purchasing a particular product. Those having ordinary skill in the art of the invention would realize that other approaches to determining environmental impacts may also be used.

Different users may have different preferences regarding which environmental impacts they most desire to avoid causing or contributing to. For example, some users may weigh more heavily human toxicity impacts compared to ozone depletion impacts or aquatic toxicity impacts. When the user signs up with system 10, information on the user's preferences is collected and stored in the environmental information component of system 10. Preferably, this information can be updated at any time by the user. Parsed data are preferably stored in a user preference vector (not shown) of dimension (i,3), in which i is the number of rows that correspond to the number of impact classes listed in product pollution vector 92 in system 10, and three columns that correspond to the user identification in the first column, impact class identifier in the second column, and the preference score in the third column. The preference score is preferably an integer on a scale of a to b, (e.g., 0 to 5) with b indicating extreme concern for the impact class and a indicating no concern for the impact class. Missing values are parsed and stored as a default value, preferably “−9.9.”

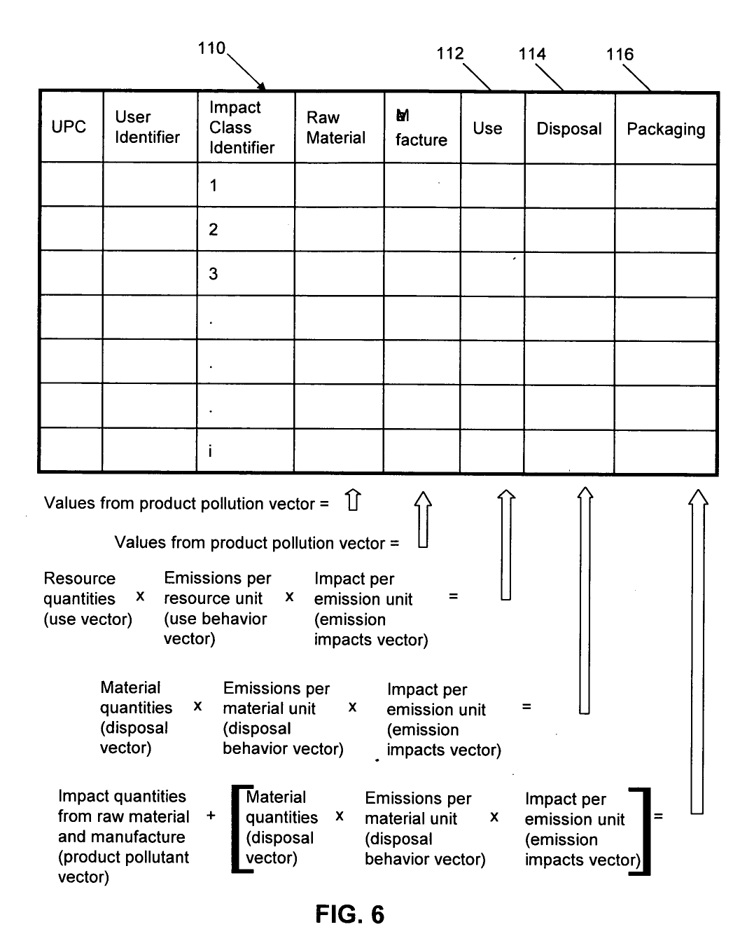

Personalized product pollutant quantities are calculated using as inputs product pollution vector 92, use vector, disposal vector, use behavior vector, disposal behavior vector, fuels emission vector, material emission vector, and emission impacts vector. The resultant values are stored in personalized product pollutant vector 110. FIG. 6 illustrates a preferred data structure for personalized product pollutant vector 110 and preferred formulas for calculating impacts associated with each user-product combination in system 10.

The first step in calculating personalized impact quantities is to transfer from product pollution vector 92 all quantities that are independent of (not affected by) the use behavior and the disposal behavior of the user. For the preferred lifecycle stages of raw material, manufacture, use, disposal, and packaging, the raw material and manufacture values from product pollution vector 92 transfer directly into personalized product pollutant vector 110 because these impacts are independent of use and disposal behavior. The pollution quantities for the use, disposal, and packaging stages are dependent upon the user's behavior, and must be calculated using the use behavior vector unless the user has chosen not to specify this behavior. In the case in which the user does not specify this behavior, default values for each impact are transferred from the product pollution vector 92 to the user's personalized product pollutant vector 110 and the step of populating personalized product pollutant vector 110 is complete. As illustrated in FIG. 6, resulting personalized product pollutant vector 110 is of dimension (i*x,n+3), in which i is the number of impact classes, x is the number of products (and/or services) in system 10, and n+3 is the number of lifecycle stages plus the UPC code, user identifier, and impact class identifier.

In the case in which the user does specify the user's behavior, the pollution quantities associated with the use, disposal, and packaging of products and services are calculated using the use vector, disposal vector, use behavior vector, disposal behavior vector, materials emission vector, fuels emission vector, and emission impacts vector. To calculate use impacts, the raw amounts of fuels and byproducts consumed during use of each product or service stored in the use vector are multiplied times the emission per resource unit values for fuels and byproducts stored in the use behavior vector. The pollution impacts by impact class are then calculated by multiplying the use emission quantities times the impact per emission unit values stored in the emission impacts vector. These pollution impacts by impact class are then stored in use column 112 of the personalized product pollutant vector 110.

To calculate the disposal impacts of products, the raw amounts of materials stored in the disposal vector are multiplied times the emissions per unit values stored in the disposal behavior vector. The resulting total emissions are multiplied times the values stored in the emission impacts vector to calculate the pollution quantities associated with the disposal of the product or service. These pollution quantities are stored in disposal column 114 of each user's personalized product pollutant vector 110.

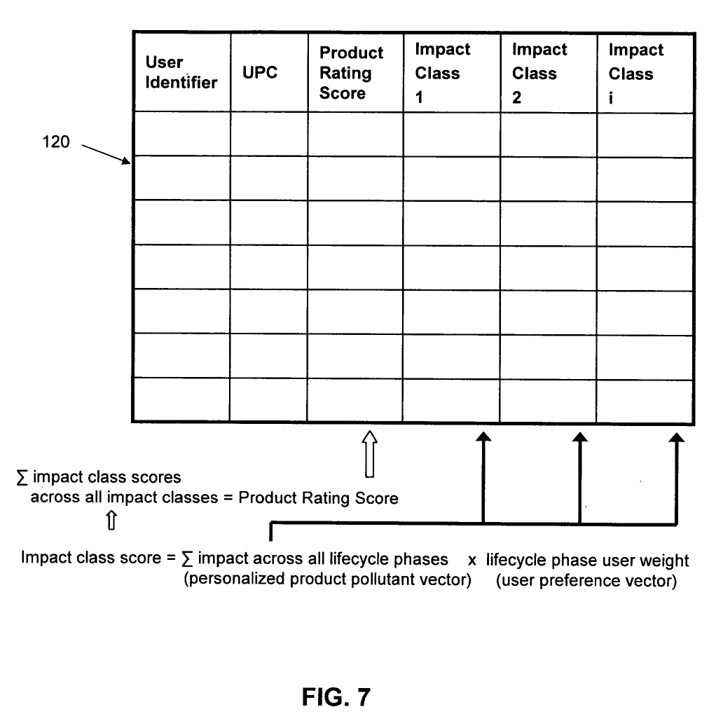

Referring again to FIG. 6, to calculate the packaging impacts of a product, the packaging raw material and manufacture impacts derived from the product lifecycle assessment are added to the packaging disposal impact, which is a personalized value. The personalized value is calculated by adjusting the packaging material disposal impacts from the product lifecycle assessment by the disposal behavior indicator obtained from the user in a similar manner as that described above for calculating the impacts of disposal of the product. in a preferred embodiment, the environmental information component of system 10 also comprises the capabilities to calculate personalized product ratings based on user preferences and price surcharges based on societal values for pollution impacts. FIG. 7 illustrates a preferred data structure for personalized product rating vector 120 and preferred formulas for calculating a product rating score for each user-product combination in system 10. The personalized product ratings are calculated using as inputs personalized product pollutant vector 110 and the user preference vector. The total pollutant values by impact class are weighted by the scores in the user preference vector and summed to obtain a total value for each product (and/or service) in accordance with the process disclosed herein. The lower the score, the higher the product is rated based on the user's preferences. If the user does not specify preferences, each impact class is weighted evenly. In a preferred embodiment, personalized product rating vector 120 also contains the cumulative environmental impacts of the product across the lifecycle stages. Preferably, additional columns are provided in personalized product rating vector 120, one for each impact class. Each column contains a value equal to the sum of the impacts of the product across all lifecycle stages for that particular impact class.

Resulting personalized product rating vector 120 is preferably of dimension (x,3+i), in which x is the number of rows that correspond to the number of products (and/or services) in system 10, three columns, with the first column being the user identifier, the second column being the product UPC code, the third column being the personalized product score, and i other columns, with i being the number of impact classes. In a preferred embodiment, the personalized product rating vector contains about 50-75 bytes per product.

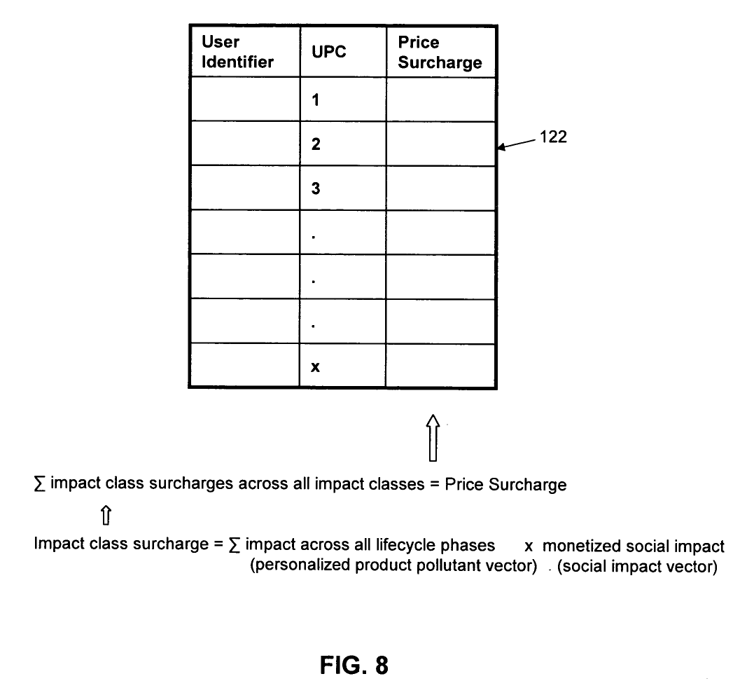

FIG. 8 illustrates a preferred data structure for personalized price surcharge vector 122 and preferred formulas for calculating price surcharges for each user-product combination in system 10. The price surcharges are calculated by multiplying the total personalized product pollutant values stored in personalized product pollutant vector 110 by impact class times monetized social impact values stored in the social impact vector. The social impact vector has dimension of (i,2), where i rows correspond to the number of impact classes, the first column is the impact class name, and the second column contains the monetized per unit societal impact. The calculation of the monetized per unit societal impact is exogenous to system 10. These impact estimates differ by country and are typically available from national government sources or research institutions. The resultant values are stored in personalized price surcharge vector 122 of dimension (x,3), with x rows that correspond to the number of products and services, the first column that contains the user identifier, the second column that contains the UPC code, and the third column that contains the price surcharge. In a preferred embodiment, the personalized price surcharge vector contains about 25-30 bytes per product and could be combined with the product rating vector if size were an issue, which would eliminate a couple of duplicate data fields.

In a preferred embodiment, personalized product rating vector 120 and personalized price surcharge vector 122 are placed in a queue for transmission to the user's computer device via a network connection or storage media after the initial calculations are complete and the personalized vectors are created. Computer software facilitates this transmission to desktop and mobile devices as described above.

In a preferred embodiment, updates to personalized product rating vector 120 and personalized price surcharge vector 122 are also placed in a queue to transmit to the user's computer device via a connection to network 20 if new products or services are added to the vectors, if the user changes his or her behavior or preference vectors, or if any values change in the other data vectors used in the calculations. Computer software facilitates this transmission to desktop and mobile devices as described above.

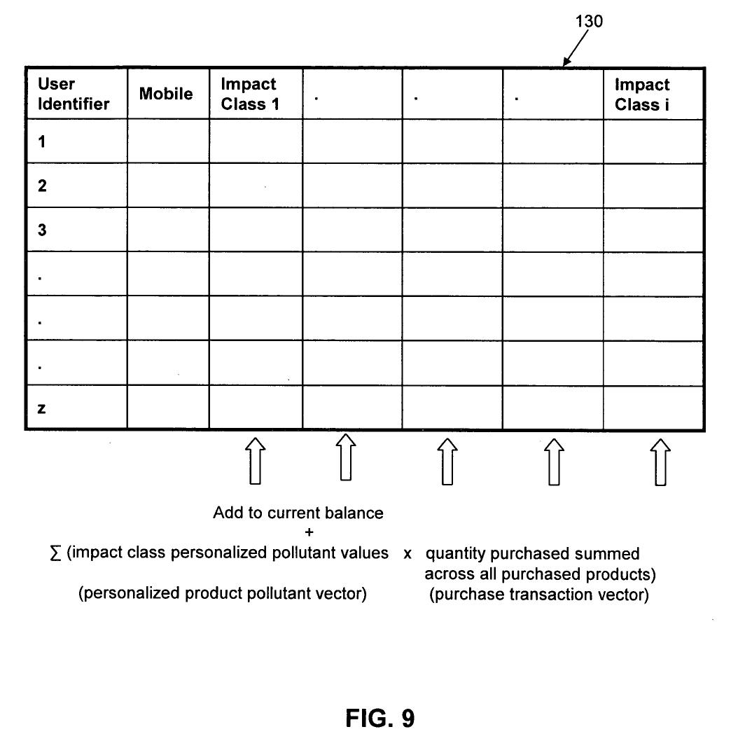

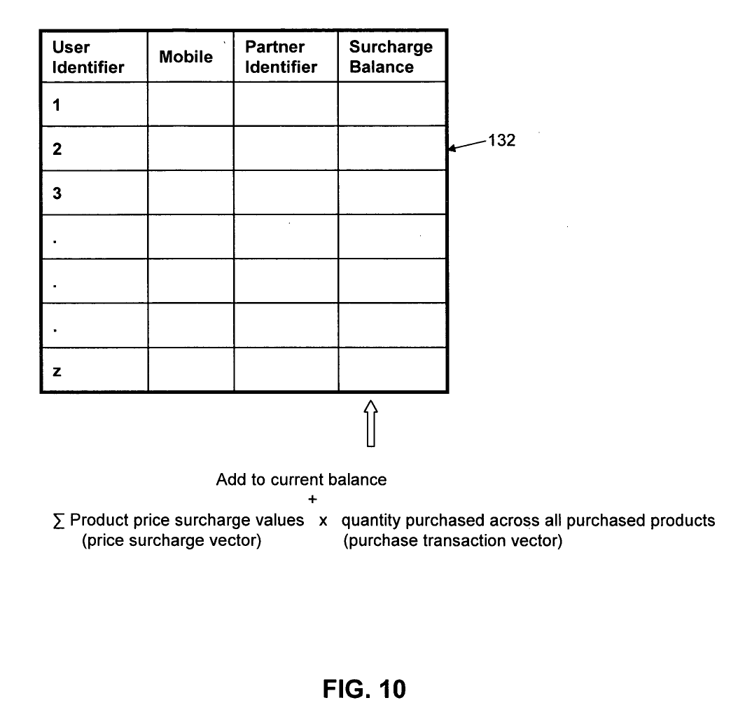

Preferred data structures used by the accounting component of the invention are illustrated in FIGS. 9 and 10. In this component of system 10, the amount of each pollutant associated with each product the user purchases as well as price surcharges associated with each product the user purchases are accounted for.

In a preferred embodiment, all price surcharges collected by system 10 are donated to one or more user-designated non-profit organizations, minus an administrative fee. Non-profit environmental organizations can also be used as marketing channels for system 10, providing this environmental information service to their members. Preferably, the channel partner or designated non-profit organization receives 100 percent of the price surcharges collected from the users of system 10, minus an administrative fee kept by the service provider. When a marketing channel partner or non-profit organization enters into an agreement with the provider of system 10, a row is preferably added in the donation account vector (not shown) of dimension (y,3), in which y rows correspond to the number of partners, the first column contains a partner identifier, the second column contains the percentage of total price surcharges to be received by the partner, and the third column contains the price surcharge balance accumulated from purchases by all the users of system 10 (affiliated users) during the current month. In a preferred embodiment, at the end of each month, the current donation account vector is archived and a new donation account vector (not shown) is created with zero balances for each partner for the next month.

In a preferred embodiment, pollutant account vector 130 and surcharge account vector 132 are created at the beginning of each month. These vectors preferably contain an accumulated pollution impact account balance and an accumulated price surcharge account balance, respectively, for purchases by each user during the month. When a new user joins system 10, a new row is preferably added to pollutant account vector 130 and surcharge account vector 132 with a zero balance.

FIG. 9 illustrates a preferred data structure for pollutant account vector 130 and a preferred formula for calculating the pollutant account balance (cumulative pollution impacts) by impact class. Pollutant account vector 130 is preferably of dimension (z,i+2), in which z rows correspond to the number of users and i+2 columns correspond to the number of impact classes plus the user identifier and a column that indicates whether the user desires offline, mobile purchasing capabilities. The formula preferably utilizes the information in personalized product pollutant vector 110 and in a purchase transaction vector (not shown), which is described below.

FIG. 10 illustrates a preferred data structure for surcharge account vector 132 and a preferred formula for calculating the surcharge account balance. Surcharge account vector 132 is preferably of dimension (z,4), in which z rows are the number of users, the first column contains the user identifier, the second column indicates whether the user desires offline, mobile purchasing capabilities, the third column contains the partner identifier for donations, and the fourth column contains the cumulative monthly balance of price surcharges.

Preferably, at the end of each month, the current pollutant account vector 130 and the current surcharge account vector 132 are archived and new vectors are created for the next month. All pollution and surcharge balances are preferably set to zero in the new vectors, while the other identifier and indicator data are carried over from the previous month.

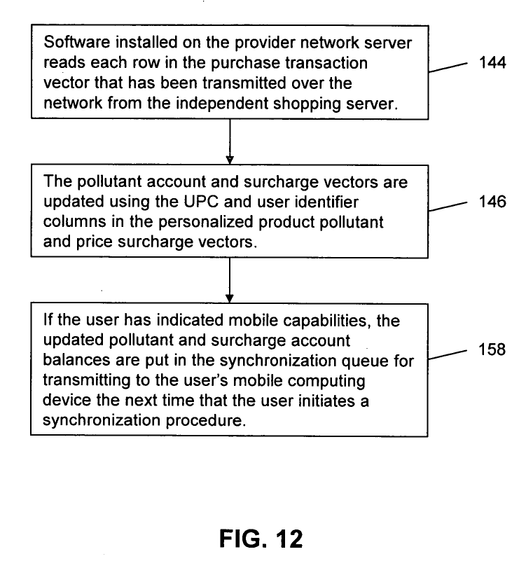

When the user makes an online product purchase or synchronizes the user's mobile device to transmit product purchases made offline, pollutant account vector 130 and surcharge account vector 132 are updated to reflect changes in the accumulated monthly balances. FIGS. 11 and 12 illustrate the account update process for offline mobile shoppers and online shoppers, respectively.

With respect to a preferred embodiment of the mobile, offline account updating process, referring to FIG. 11, the first step in the account updating process is that the user connects mobile device 16 to network 20 in step 140. In step 142, the user initiates updating of personalized product pollutant vector 110 and personalized price surcharge vector 122 by transmitting purchase transaction vector (not shown) to server 12. Software installed on server 12 reads each row in purchase transaction vector in step 144. In step 146, pollutant account vector 130 and surcharge account vector 132 are updated in accordance with the process presented herein. The updated pollutant account vector 130 and surcharge account vector 132 are transmitted to mobile computing device 16 in step 148. In step 150, the purchase transaction vector on mobile computing device 16 is overwritten.

With respect to a preferred embodiment of the online account updating process, referring to FIG. 12, the first step in the account updating process is that software installed on server 12 reads the data in the purchase transaction vector that has been transmitted over network 20 from an independent shopping server in step 144. In step 146, pollutant account vector 130 and surcharge account vector 132 are updated in accordance with the process presented herein. Then, if the user has indicated mobile capabilities, the updated pollutant account vector 130 and surcharge account vector 132 are then placed in the queue for transmission to mobile computing device 16 in step 158.

The input vectors used during the update procedure are preferably personalized product pollutant vector 110, personalized price surcharge vector 122, and purchase transaction vector. The purchase transaction vector is preferably of dimension (p,3), in which p is the number of rows that correspond to the number of unique products purchased, the first column is a date/time stamp, the second column is the product UPC, and the third column is the quantity purchased.

To update the pollutant balances in pollutant account vector 130, the number of units purchased is multiplied times the impact values for the product in each personalized product pollutant vector 110 for each unique product in each purchase transaction vector, and the resulting sum value for each impact class is added to the balances in pollutant account vector 130. To update the surcharge balances, the price surcharge values stored in each personalized price surcharge vector 122 are multiplied times the quantity purchased and then summed across all products in each purchase transaction vector, with the resulting value added to the balance stored in surcharge account vector 132 in the appropriate user row.

At the end of each month, the values in pollutant account vector 130 and surcharge account vector 132 are put in the synchronization queue of system 10 for all users in which the columns in pollutant account vector 130 and surcharge account vector 132 indicate that the user desires offline, mobile purchasing capabilities. These values are transmitted to the user the next time that the user synchronizes the user's account over the network per the process defined below.

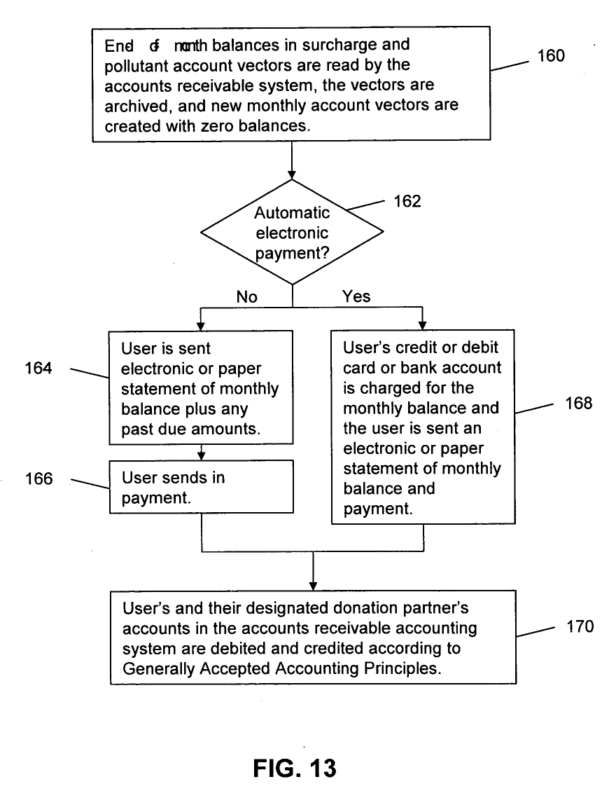

In a preferred embodiment, each user is billed monthly for the user's balance in surcharge account vector 132. This invoicing can be electronic or on paper. FIG. 13 illustrates the accounts receivable process for user surcharge accounts.

Referring to FIG. 13, end-of-month balances in pollutant account vector 130 and surcharge vector 132 are read by the accounts receivable system, the old vectors are archived and new vectors are created in step 160. In step 162, a determination is made as to whether the user has authorized automatic electronic payment. If the answer is “No,” the user is sent an electronic or paper statement in step 164 and the user sends in the payment in step 166. If the answer is “Yes,” the user's credit card or debit card is charged and a statement is sent to the user in step 168. In step 170, the user's account and the donation partner's account are debited and credited.

For each user, the amount in the surcharge account vector is transferred to an accounts receivable accounting system either electronically through database software or manually through data entry in an accounts receivable accounting system. A statement is preferably sent to each user that includes the accumulated surcharge amount for the month, the amount of pollution impacts for the month by impact class, the total pollution impacts for the past twelve months by impact class, and the total surcharges for the past twelve months. Also included on the statement are any surcharges that are past due. In a preferred embodiment, users have the option to set up automatic credit or debit card payments of the surcharges using a marketing channel partner's affiliated card or an independently-issued card.

When a payment for the invoiced price surcharges balance is received from a user, debit and credit entries are made in the accounts receivable system following Generally Accepted Accounting Principles. The entries are made to both the user's account and to their designated donation partner's account.

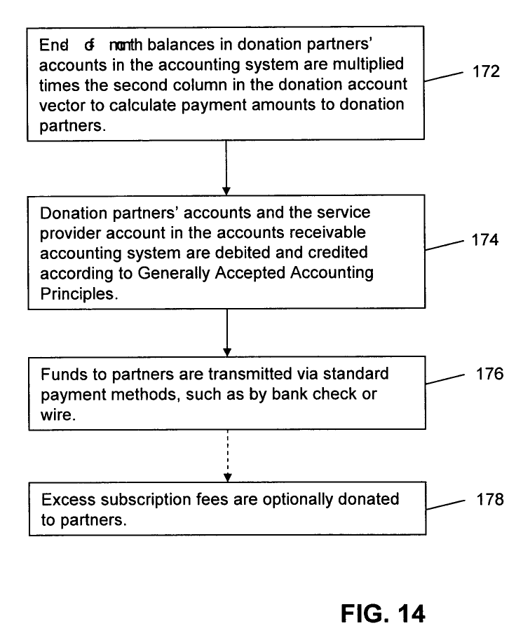

In a preferred embodiment, at the end of each month, payment is sent to each donation partner containing its portion of surcharges collected over the past month. FIG. 14 illustrates the accounts payable process for donation partners. In step 172, amounts to be paid to each donation partner are calculated. The balance shown in the third column in the partner's row in the donation account vector (not shown) is multiplied times the second column to determine the amount of payment to the partner. The remaining portion is retained by the service provider (e.g., the operator of system 10) as revenue in payment for administering the account. The donation partner's account and the service provider's account (e.g., the accounts of the operator of system 10) are debited and credited in step 174 following Generally Accepted Accounting Principles. In step 176, funds are transmitted to the donation partners. If the service provider is a non-profit organization itself, in step 178 it may choose to donate excess subscription fees at the end of its fiscal year to donation partners according to a formula approved by its governing body.

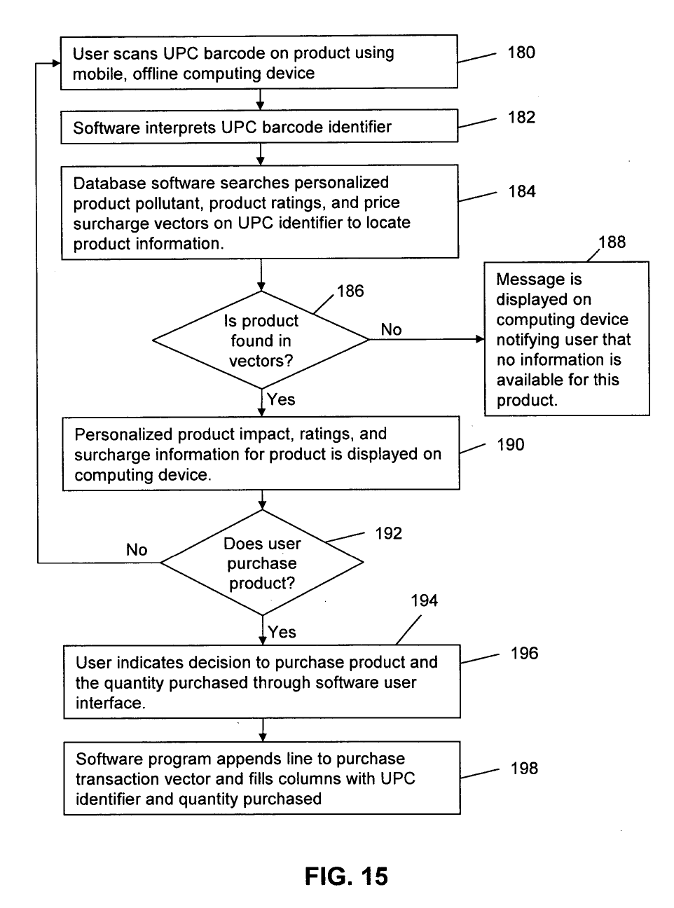

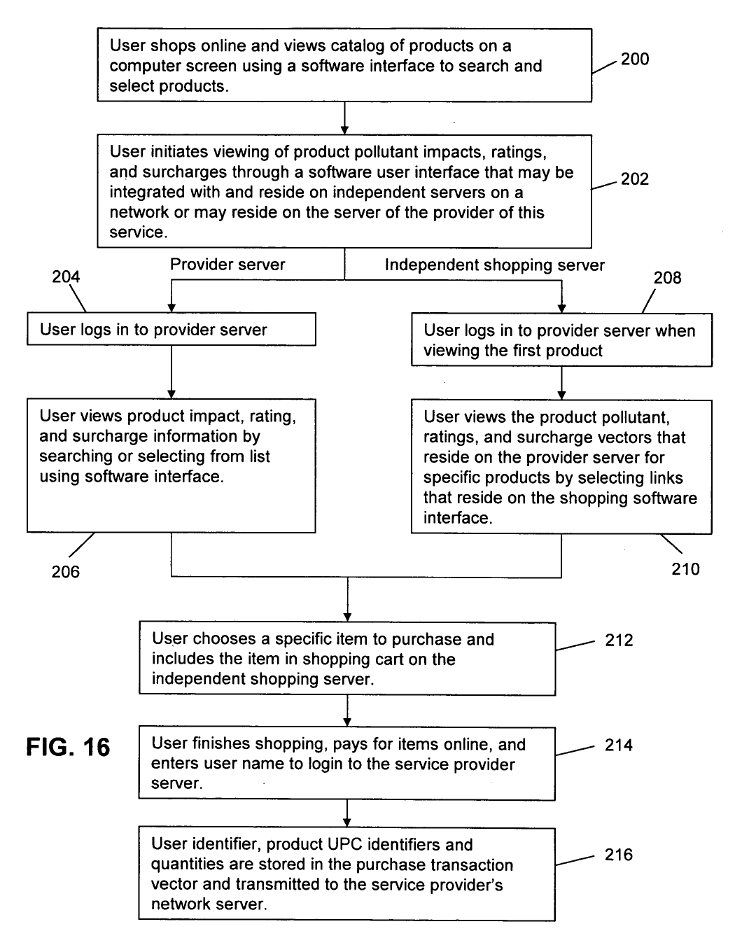

Preferred processes for mobile, offline purchasing and for online purchasing that are parts of the software user interface component of the invention are illustrated in FIGS. 15 and 16. In this component of system 10, the purchase transaction vectors of each user are populated.

In a preferred embodiment, a new user account is created when a user initiates service with system 10. The user's name, billing address, and contact information is added to the accounts receivable system along with the date on which service was initiated. The user is preferably charged an initial subscription fee through an entry in the accounts receivable system, and is charged periodically thereafter for continuing subscription to the service.

Rows are preferably added to the pollutant account vector 130 and surcharge account vector 132 in accordance with the process defined above. In this embodiment, the partner identifier value is collected and inserted in the second column of surcharge account vector 132 if the user is affiliated with a partner. In this case, the surcharges that are collected from the user are donated to the partner (minus the administrative fee). In the case of an unaffiliated user, the user preferably designates a non-profit organization to which to donate the surcharges. A non-profit organization could choose to be a marketing partner, in which case the partner and non-profit organization are the same. For example, in a preferred embodiment, a non-profit organization (e.g., The Nature Conservancy) enters into a distribution agreement with the service provider (of system 10) and markets this service to its member list. Any member that signs up would then donate surcharges to The Nature Conservancy. In another preferred embodiment, an individual could join system 10 through direct marketing by the service provider and choose a non-profit group to which to donate the surcharges. In this embodiment, because no marketing channels were used to reach the customer, the marketing partner does not exist for this customer, but the customer still chooses a non-profit organization to which to donate surcharges. This organization designation can preferably be changed at any time by the user. Ownership of system 10 may be either by a for-profit organization or a non-profit organization.

The user also indicates whether offline, mobile purchasing capabilities are desired or whether online capabilities only are desired. In a preferred embodiment, if online capabilities only are indicated, the second column in surcharge account vector 132 is set to false, and the last column in pollutant account vector 130 is set to false. The user sets up a login name and password for access to the online information. This information is preferably stored in server 12 or database 14 and maintained by a network administrator.

The user can also set up automatic payments for monthly surcharge amounts at the time service with system 10 is initiated, or any time thereafter. The automatic payment information is stored in the accounts receivable system.

In a preferred embodiment, at the time the user initiates service with system 10 or any time thereafter, the user can enter into system 10 the user's preferences concerning the importance of pollution impact classes. Preferences are preferably recorded on an integer scale, with the lowest number indicating no concern for that impact class and the highest number indicating that the user is extremely concerned about that impact class. User responses are stored in the user's user preference vector in accordance with the process defined above. These responses are used to calculate the personalized product ratings specific to the user, which are stored in the user's personalized product rating vector 120.

In a preferred embodiment, at the time a user initiates service with system 10 or anytime thereafter, the user can enter into system 10 the user's product use behavior and disposal behavior. The information on product use behavior and disposal behavior is stored in the user's use behavior vector and the user's disposal behavior vector in accordance with the process defined above.

In a preferred embodiment, at the time a user initiates service with system 10, the values stored in personalized product rating vector 120 and personalized price surcharge vector 122 are calculated and put in the queue for downloading to and installing on the user's mobile computing device in accordance with the processes defined above. The mobile user's software interface and the data vectors are preferably downloaded and installed through computing middleware software that operates within the mobile computing device's operating system and the associated desktop computing operating system.

The user's mobile device with attached or embedded barcode reader is used for purchasing products in stores. FIG. 15 illustrates a preferred purchasing process for mobile offline users. Mobile device 16 is not connected to a network and provides information through the downloaded and installed user interface and data vectors. Alternatively, the user may shop with a portable shopping system provided by the store (e.g., in-store mobile device) onto which the information service of system 10 has been loaded and installed. In the latter case, default product pollutant, product rating, and price surcharge values are preferably used across all users of the device who shop in the store. This default values approach may also be used with any of the user's other computing devices.

In a preferred embodiment, to view product rating, surcharge, or pollutant information for any product, the user scans the UPC or other barcode for the product in step 180. The software reads and interprets the barcode in step 182 and searches the information contained in personalized product rating vector 120 and personalized price surcharge vector 122 using the UPC identifier to locate the scanned product in step 184. If the scanned product is not found in step 186, a message is displayed notifying the user that no information is available for the scanned product in step 188.

If, the product is located in the data vectors in step 186 after the product barcode has been scanned, the product pollutant, product ratings, and price surcharge information is preferably displayed on the screen of mobile computing device 16 through the software interface in step 192. Preferably, the user interface provides capabilities to display the results in graphic, tabular, and text formats. In a preferred embodiment, the user interface also allows the user to review information on other products that fall in the same product category. This feature allows the user to compare the substitute product's rating and price surcharge information to the information on the product selected by scanning its barcode. Alternatively, the user can select a product category and view products by selecting the name of the product on the screen.

For online shopping, a link is preferably provided in the vicinity of the product listing in the online store to display product pollutant information, product rating, and price surcharge information to the user. Alternatively, the user can sign on the service provider's server 12 and search or browse product listings to view the product rating and impacts and price surcharge information.

If the user decides to purchase the product in step 192, the user indicates that decision and the quantity to be purchased in step 196. A line is then appended to the purchase transaction vector in step 198. If not, the user returns to step 180.

For offline, mobile purchases, the user records the purchase quantity for the selected product using the software interface. The purchase information is preferably recorded in the purchase transaction vector that resides on mobile computing device 16 by appending a new row. The number of rows in this vector continues to increase over multiple shopping trips if the user has not transmitted the vector over network 20 to update pollutant account vector 130 and surcharge account vector 132 in accordance the process as defined above.

For offline, mobile purchases recorded on a store's portable shopping system, the purchase transaction vector is preferably transferred to the user's smart card at the time the user finishes shopping. The vector is preferably transmitted to the smart card using infrared technology. For online purchases, a user identifier and the purchase transaction vector containing product UPC identifiers and purchase quantities are transmitted over network 20 at the time the user submits the order for the online purchase.

The data vectors on the user's mobile computing device are synchronized over network 20 with the data vectors on network server 12. Any updates in the queue on network server 12 are synchronized at this time. The data vectors to be synchronized include the purchase transaction vector, personalized product rating vector 120, personalized price surcharge vector 122, pollutant account vector 130, and surcharge account vector 132. Synchronization is performed using conventional computerized middleware and database software.

FIG. 16 illustrates a preferred purchasing process for online shopping users. Preferably, the user interface on personal computer 18 provides the same capabilities for viewing information as the user interface on mobile unit 16. The online user interface requires that the user login before viewing the information.

Referring to FIG. 16, the user shops online and views catalogs of products in step 200. In step 202, the user initiates viewing of product environmental information. If the user is accessing shopping information on a provider server (e.g., server 12 operated by the operator of system 10), then the user logs in to server 12 in step 204. In step 204, the user views product information on server 12. If the user is accessing shopping information on an independent shopping server, the user logs in to that server when viewing the first product in step 208. In step 210, the user views product environmental information that resides on the provider server (e.g., server 12) by selecting links on pages downloaded from the independent shopping server. The user chooses a specific product to purchase in step 212. In step 214, the user finishes shopping, pays for the chosen product and enters a user name and password to log into server 12. The user's user ID, product UPC identifiers and quantities are stored in the purchase transaction vector and transmitted to server 12 in step 216.

Table 1 characterizes the data vectors used in preferred embodiments of the invention. The source of the data stored in a vector is termed “endogenous” if is calculated by system 10 and “exogenous” if it is input to system 10. Relational keys for a relational database embodiment of system 10 are also presented.

TABLE 1
Preferred Data Vector Listing

| Vector Name | Data source | Relational Keys |
|---|---|---|
| Product pollution | Endogenous | UPC, ImpactID |
| Use | Endogenous | ResourceID |
| Disposal | Endogenous | ResourceID |
| Use behavior | Endogenous | UserID, ResourceID |
| Disposal behavior | Endogenous | UserID, ResourceID |
| User preference | Endogenous | UserID, ImpactID |
| Fuels emission | Exogenous | ResourceID, EmissionID |
| Material emission | Exogenous | ResourceID, EmissionID |
| Emission impacts | Exogenous | EmissionID |
| Personalized product | Endogenous | UserID, UPC, ImpactID |
| pollutant | | |
| Personalized product rating | Endogenous | UserID, UPC |
| Social impact | Exogenous | ImpactID |
| Personalized price | Endogenous | UserID, UPC |
| surcharge | | |
| Donation account | Endogenous | PartnerID |
| Pollutant account | Endogenous | UserID, ImpactID |
| Surcharge account | Endogenous | UserID, PartnerID |
| Purchase transaction | Endogenous | UserID, UPC |

Many variations of the invention will occur to those skilled in the art. Some variations include personalizing environmental data. Other variations call for using typical environmental data. All such variations are intended to be within the scope and spirit of the invention.

Although some embodiments are shown to include certain features, the applicant(s) specifically contemplate that any feature disclosed herein may be used together or in combination with any other feature on any embodiment of the invention. It is also contemplated that any feature may be specifically excluded from any embodiment of an invention.

What is claimed is:

1. A computer-implemented method for managing personalized environmental information for a user regarding a product, said method comprising:
collecting a plurality of pollution impact data from a lifecycle assessment of the product and associating the pollution impact data with a product identifier assigned to the product;
parsing the pollution impact data and storing the parsed pollution impact data in a product pollution vector using default assumptions about use behavior and disposal behavior;
storing portions of the pollution impact data to be used in calculating use impacts and disposal impacts in a use vector and a disposal vector, respectively;
collecting information on the emissions of the fuel mix used to generate electricity consumed by products and services during use by the user and storing it in a use behavior vector;
collecting information on the recycling and reuse of the byproduct streams of the user and the emissions of disposed byproduct streams and storing it in a disposal behavior vector; and
calculating personalized product pollutant quantities using as inputs said product pollution vector, said use vector, said disposal vector, said use behavior vector, said disposal behavior vector and storing said personalized product pollutant quantities in a personalized product pollutant vector.

2. The method of claim 1 further comprising:
collecting information on the environmental impact preferences of the user and storing it in a user preference vector;
calculating a product rating score for the product using as inputs said personalized product pollutant vector and said user preference vector and storing the result in a personalized product rating vector; and
calculating a cumulative impact value for the product for each impact class and storing the result in the personalized product rating vector.

3. The method of claim 2 further comprising:
collecting information on monetized societal impact of environmental impacts and storing the information in a social impact vector; and
calculating a price surcharge for the product using said personalized product pollutant vector and said social impact vector as inputs and storing the result as a personalized price surcharge vector.

4. The method of claim 3 further comprising:
transmitting the data contained in said personalized product rating vector and said price surcharge vector to the user's computer device via a network connection or a storage medium for display to the user.

5. The method of claim 4 further comprising:
collecting a designation of a non-profit organization or a marketing channel partner from the user and storing it;
donating the price surcharge for the product indicated by said price surcharge vector, minus an administrative fee, to the user-designated non-profit organization or marketing channel partner.

6. The method of claim 3 further comprising:
updating a pollution account of the user by adding said personalized product pollutant quantities to a first total in a pollutant account vector; and
updating the surcharge account of the user by adding said price surcharge to a second total in a surcharge account vector.

7. The method of claim 6 further comprising:
transmitting the contents of a purchase transaction vector from a mobile computing device to a provider network server before performing the updating steps;
transmitting the contents of said pollutant account vector and said surcharge vector from said provider network server to said mobile computing device;
updating said pollutant account vector and said surcharge account vector to produce an updated pollutant account vector and an updated surcharge account vector; and
resetting said purchase transaction vector in the mobile computing device.

8. The method of claim 6 further comprising:
transmitting the contents of a purchase transaction vector from a shopping server to a provider network server before performing the updating steps;
if the user has a mobile computing device, transmitting the contents of said pollutant account vector and said surcharge vector from said provider network server to said mobile computing device;
updating said pollutant account vector and said surcharge account vector to produce an updated pollutant account vector and an updated surcharge account vector; and
if the user has said mobile computing device, placing said updated pollutant account vector and the updated surcharge account vector in a synchronization queue for transmission to said mobile computing device.

9. The method of claim 8 further comprising:
transferring an amount in said updated surcharge account vector to an accounts receivable accounting system;
sending a statement to the user; and
accepting a payment from the user.

10. The method of claim 9 further comprising:
calculating a payment amount to said user-designated non-profit organization or marketing channel partner; and
transmitting said payment amount to said user-designated non-profit organization or marketing channel partner.

11. A computer-implemented method for calculating and communicating personalized product environmental information to a user, and for accounting for pollution resulting from purchasing a product, said method comprising:
scanning a barcode on the product using a mobile, offline computing device;
identifying the product;
searching a database for a product rating vector and a price surcharge vector that are associated with the product;
displaying to the user personalized product impact information, a personalized product rating and a personalized price surcharge that are associated with the product;
accepting an indication that the product has been purchased; and
appending a product purchase line to a purchase transaction vector.

12. A computer-implemented method for calculating and communicating personalized product environmental information to a user at a point of purchase, and for accounting for pollution resulting from purchasing a product, said method comprising:
selecting the product and transmitting the selection to a server;
searching a database for a personalized product pollutant vector, a product rating vector and a price surcharge vector that are associated with the product;
displaying to the user personalized product impact information, a personalized product rating and a personalized price surcharge that are associated with the product;
transmitting an indication to said server that the product has been purchased;
appending a product purchase line to a purchase transaction vector; and
transmitting the contents of said purchase transaction vector to said server.

13. A computer-implemented method for calculating and communicating personalized product environmental information to a user at a point of purchase of each of a plurality of products, and for accounting for pollution resulting from purchasing each product, said method comprising:
accepting life cycle pollution data and a product code for each product;
accepting registration data from the user;
creating a pollutant account vector and a surcharge account vector for the user;
accepting preference data and behavior data from the user and storing said data in a preference vector and a behavior vector;
calculating personalized product pollutant quantities for the user for each product and storing said quantities in a personalized product pollutant vector;
calculating a personalized product rating and a personalized price surcharge for the user for each product and storing them in a personalized product rating vector and a personalized price surcharge vector;
placing said personalized product rating vector and said personalized price surcharge vector and/or software updates in a synchronization queue in a server;
connecting the user's computing device with said server and storing said personalized product rating vector and said personalized price surcharge vector and/or software updates on said computing device;
inputting an indication of the user's interest in a particular product to said computing device;
displaying personalized product environmental information relating to said particular product to the user by means of said computing device;
inputting a decision by the user to purchase said particular product to said computing device;
transmitting said decision to said server;
updating a pollutant account vector and a surcharge account vector of the user;
charging the user a surcharge amount associated with the purchase of said particular product; and
paying at least a portion of the surcharge amount to a selected non-profit organization.

14. A computer-implemented system for managing personalized environmental information for a user regarding a product, said system comprising:
means for collecting a plurality of pollution impact data from a lifecycle assessment of the product and associating the pollution impact data with a product identifier assigned to the product;
means for parsing said pollution impact data and storing parsed pollution impact data in a product pollution vector;
means for storing a portion of said pollution impact data to be used in calculating use impacts and disposal impacts in a use vector and a disposal vector, respectively;
means for collecting information on the emissions of the fuel mix used to generate electricity consumed by products and services during use by the user and storing it in a use behavior vector;
means for collecting information on the recycling and reuse of the byproduct streams of the user and the emissions of disposed byproduct streams and storing it in a disposal behavior vector; and
means for calculating personalized product pollutant quantities using as inputs said product pollutant vector, said use vector, said disposal vector, said use behavior vector, said disposal behavior vector and means for storing said personalized product pollutant quantities in a personalized product pollutant vector.

15. The system of claim 14 further comprising:
means for collecting information on the environmental impact preferences of the user and storing it in a user preference vector;
means for calculating a product rating score for the product using as inputs said personalized product pollutant vector and said user preference vector and storing the result in a personalized product rating vector; and
means for calculating a cumulative impact value for the product for each impact class and storing the result in said personalized product rating vector.

16. The system of claim 15 further comprising:
means for collecting information on monetized societal impact of environmental impacts and storing the information in a social impact vector; and
means for calculating a price surcharge for the product using said personalized product pollutant vector and said social impact vector as inputs and storing the result as a personalized price surcharge vector.

17. The system of claim 16 further comprising:
means for transmitting the data contained in said personalized product rating vector and said price surcharge vector to the user's computer device via a network connection or a storage medium for display to the user.

18. The system of claim 17 further comprising:
means for collecting a designation of a non-profit organization or a marketing channel partner from the user and storing it; and
means for donating the price surcharge indicated by said price surcharge vector, minus an administrative fee, to the user-designated non-profit organization or marketing channel partner.

19. The system of claim 16 further comprising:
means for updating a pollution account of the user by adding said personalized product pollutant quantities to a first total in a pollutant account vector; and
means for updating a surcharge account of the user by adding said price surcharge to a second total in a surcharge account vector.

20. The system of claim 19 further comprising:
means for transmitting the contents of a purchase transaction vector from a mobile computing device to a provider network server; and
means for transmitting the contents of said pollutant account vector and said surcharge vector from said provider network server to said mobile computing device;
means for updating said pollutant account vector and said surcharge account vector to produce an updated pollutant account vector and an updated surcharge account vector; and
means for resetting said purchase transaction vector in said mobile computing device.

21. The system of claim 18 further comprising:
means for transmitting the contents of a purchase transaction vector from a shopping server to a provider network server;
means for transmitting the contents of said pollutant account vector and said surcharge vector from said provider network server to said mobile computing device; and
means for updating said pollutant account vector and said surcharge account vector to produce an updated pollutant account vector and an updated surcharge account vector; and
means for placing said updated pollutant account vector and said updated surcharge account vector in a synchronization queue for transmission to a mobile computing device, if the user has such a device.

22. The system of claim 20 further comprising:
means for transferring an amount in said updated surcharge account vector to an accounts receivable accounting system;
means for sending a statement to the user; and
means for accepting a payment from the user.

23. The system of claim 22 further comprising:
means for calculating a payment amount to said user-designated non-profit organization or marketing channel partner; and
means for transmitting said payment amount to said user-designated non-profit organization or marketing channel partner.

24. A computer-implemented system for calculating and communicating personalized product environmental information to a user, and for accounting for pollution resulting from purchasing a product, said method comprising:
means for scanning a barcode on the product using a mobile, offline computing device;
means for identifying the product;
means for searching a database for a product rating vector and a price surcharge vector that are associated with the product;
means for displaying to the user personalized product impact information, a personalized product rating and a personalized price surcharge that are associated with the product;
means for accepting an indication that the product has been purchased; and
means for appending a product purchase line to a purchase transaction vector.

25. A computer-implemented system for calculating and communicating personalized product environmental information to a user at a point of purchase, and for accounting for pollution resulting from purchasing a product, said system comprising:
means for selecting the product and for transmitting the selection to a server;
means for searching a database for a personalized product pollutant vector, a personalized product rating vector and a personalized price surcharge vector that are associated with the product;
means for displaying to the user personalized product impact information, a personalized product rating and a personalized price surcharge that are associated with the product;
means for transmitting an indication to the server that the product has been purchased;
means for appending a product purchase line to a purchase transaction vector; and
means for transmitting the contents of said purchase transaction vector to the server.

26. A computer-implemented system for calculating and communicating personalized product environmental information to a user at a point of purchase of each of a plurality of products, and for accounting for pollution resulting from purchasing each product, said system comprising:
means for accepting life cycle pollution data and a product code for each product;
means for accepting registration data from the user;
means for creating a pollutant account vector and a surcharge account vector for the user;
means for accepting preference data and behavior data from the user and storing said data in a preference vector and a behavior vector;
means for calculating personalized product pollutant quantities for the user for each product and storing said quantities in a personalized product pollutant vector;
means for calculating a personalized product rating and a personalized price surcharge for the user for each product and storing them in a personalized product rating vector and a personalized price surcharge vector;
means for placing said personalized product rating vector and said personalized price surcharge vector and/or software updates in a synchronization queue in a server;
means for connecting the user's computing device with said server and storing said personalized product rating vector and said personalized price surcharge vector and/or software updates on said computing device;
means for inputting an indication of the user's interest in a particular product to said computing device;
means for displaying personalized product environmental information to the user by means of said computing device;
means for inputting a decision by the user to purchase said particular product to said computing device;
means for transmitting said decision to said server;
means for updating a pollutant account vector and a surcharge account vector of the user;
means for charging the user a surcharge amount associated with the purchase of the particular product; and
means for paying at least a portion of the surcharge amount to a selected non-profit organization.

27. A computer-implemented method for calculating and communicating personalized product environmental information to a user, and for accounting for pollution resulting from purchasing a product, said method comprising:
a step for scanning a barcode on the product using a mobile, offline computing device;
a step for identifying the product;
a step for searching a database for a product rating vector and a price surcharge vector that are associated with the product;
a step for displaying to the user personalized product impact information, a product rating and a price surcharge that are associated with the product;
a step for accepting an indication that the product has been purchased; and
a step for appending a product purchase line to a purchase transaction vector.

28. A computer-implemented method for calculating and communicating personalized product environmental information to a user at a point of purchase, and for accounting for pollution resulting from purchasing a product, said method comprising:
a step for selecting the product and transmitting the selection to a server;
a step for searching a database for a personalized product pollutant vector, a product rating vector and a price surcharge vector that are associated with the product;
a step for displaying to the user personalized product impact information, a product rating and a price surcharge that are associated with the product;
a step for transmitting an indication to the server that the product has been purchased;
a step for appending a product purchase line to a purchase transaction vector; and
a step for transmitting the contents of the purchase transaction vector to the server.

29. A computer-implemented method for calculating and communicating personalized product environmental information to a user at a point of purchase of each of a plurality of products, and for accounting for pollution resulting from each purchased product, said method comprising:
a step for accepting life cycle pollution data and a product code for each product;
a step for accepting registration data from the user;
a step for creating a pollutant account vector and a surcharge account vector for the user;
a step for accepting preference data and behavior data from the user and storing said data in a preference vector and a behavior vector;
a step for calculating personalized product pollutant quantities for the user for each product and storing said quantities in a personalized product pollutant vector;
a step for calculating a personalized product rating and a personalized price surcharge for the user for each product and storing them in a personalized product rating vector and a personalized price surcharge vector;
a step for placing said personalized product rating vector and said personalized price surcharge vector and/or software updates in a synchronization queue in a server;
a step for connecting a user's computing device with said server and storing said personalized product rating vector and said personalized price surcharge vector and/or software updates on said computing device;
a step for inputting an indication of the user's interest in a particular product to said computing device;
a step for displaying personalized product environmental information relating to said particular product to the user by means of said computing device;
a step for inputting a decision by the user to purchase said particular product to said computing device;
a step for transmitting said decision to said server;
a step for updating a pollutant account vector and a surcharge account vector of the user;
a step for charging the user a surcharge amount associated with the purchase of the particular product; and
a step for paying at least a portion of the surcharge amount to a selected non-profit organization.

30. An apparatus for storing and retrieving information associated with various coded items, said apparatus comprising:
a reading device for reading codings associated with individual items to produce coding signals;
a storage unit for storing societal impact information associated with individual items at respective storage addresses, each address being accessible through a corresponding address signal;
a first data processing unit for receiving coding signals read by said reading device and transmitting address signals to said storage unit to retrieve stored societal impact information from the corresponding storage addresses, wherein said first data processing unit comprises a coding unit which in response to receipt of at least one coding signal produces an associated address signal for transmission to said storage unit;
a second data processing unit for calculating personalized product ratings and personalized price surcharges and for accounting for cumulative societal impacts and cumulative price surcharges associated with the purchase of selected individual items by a user of the apparatus; and
an output unit for making retrieved societal impact information, personalized product ratings, personalized price surcharges, cumulative societal impacts and cumulative price surcharges available to the user of the apparatus.

31. A process for storing and retrieving information associated with various coded items, said process comprising:
reading codings associated with individual items with a reading device to produce coding signals;
storing societal impact information associated with individual items at respective storage addresses in a storage unit, each address being accessible through a corresponding address signal;
receiving coding signals read by said reading device at a first data processing unit and transmitting address signals to said storage unit to retrieve stored societal impact information from the corresponding storage addresses;
calculating personalized product ratings and personalized price surcharges and accounting for cumulative societal impacts and cumulative price surcharges associated with the purchase of selected individual items by a user; and
making retrieved societal impact information, personalized product ratings, personalized price surcharges, cumulative societal impacts and cumulative price surcharges available to the user.

32. An apparatus for generating personalized product information for an individual comprising:
means for inputting personal data relating to the individual;
means for calculating personalized product ratings and personalized price surcharges;
means for accounting for cumulative societal impacts and cumulative price surcharges associated with the purchase of selected products by the individual;
barcode means for inputting a code identifying at least one product that the individual is considering purchasing;
processor means under the control of a computer program for associating said code with said personalized product ratings and said personalized price surcharges pertinent to said at least one product that the individual is considering purchasing;
means for outputting said personalized product ratings and said personalized price surcharges to the individual pertinent to said at least one product identified by said code; and
means for outputting information to the individual concerning said cumulative societal impacts and said cumulative price surcharges associated with purchasing said at least one product identified by said code.

33. A computer-implemented process for generating personalized product information for an individual comprising:
inputting personal data relating to the individual;
calculating personalized product ratings and personalized price surcharges;
accounting for cumulative societal impacts and cumulative price surcharges associated with the purchase of selected products by the individual;
inputting a code identifying at least one product that the individual is considering purchasing;
associating the code with said personalized product ratings and said personalized price surcharges pertinent to said at least one product that the individual is considering purchasing;
outputting said personalized product ratings and said personalized price surcharges to the individual pertinent to said at least one product identified by said code; and
outputting information to the individual concerning said cumulative societal impacts and said cumulative price surcharges associated with purchasing said at least one product identified by said code.

34. A system for internalizing the societal cost of a product purchased by a user, said system comprising:
a product database having personalized product ratings and personalized price surcharges corresponding to a plurality of products;
means for selecting a particular product listed in said product database;
means for displaying a personalized product rating and a personalized price surcharge associated with said particular product; and
means for accounting for cumulative societal impacts and cumulative price surcharges associated with a purchase of said particular product by the user.

35. A technique for internalizing the societal cost of a product purchased by a user, said technique comprising:
providing a product database having personalized product ratings and personalized price surcharges corresponding to a plurality of products;
selecting a particular product listed in said product database;
displaying a personalized product rating and a personalized price surcharge associated with said particular product; and
accounting for cumulative societal impacts and cumulative price surcharges associated with a purchase of said particular product by the user.

36. A method for providing information to a consumer regarding environmental aspects relating to the production, use and disposal of a product, said method comprising:
reading a bar code positioned on the product or its packaging;
transmitting information contained in said bar code to a computer;
evaluating a database of information based on the transmitted information contained in said bar code;
receiving a personalized product rating and a personalized price surcharge related to the production, use and disposal of the product residing in said database of information, whereby the consumer can make an informed decision about whether to purchase the product; and
if the consumer purchases the product, accounting for cumulative societal impacts and cumulative price surcharges associated with a purchase of the product.

37. A system for providing information to a consumer regarding environmental aspects relating to the production and use and disposal of a product by a consumer, said system comprising:
a bar code reader for reading a bar code;
a processor for evaluating a database of information and providing a personalized product rating and a personalized price surcharge to the consumer related to the production, use and disposal of the product identified by said bar code, and for accounting for cumulative societal impacts and cumulative price surcharges associated with a purchase of the product identified by said bar code by the consumer.

38. A system for providing information to a consumer regarding environmental aspects relating to the production and use and disposal of a product by a consumer, said system comprising:
a input device for selecting the product;
a processor for evaluating a database of information and providing a personalized product rating and a personalized price surcharge to the consumer related to the production, use and disposal of said selected product, and for accounting for cumulative societal impacts and cumulative price surcharges associated with a purchase of said selected product by the consumer.

39. A computer-readable medium having computer-executable instructions for performing the process of claim 31.

40. A computer-readable medium having computer-executable instructions for performing the process of claim 33.

41. A computer-readable medium having computer-executable instructions for performing the technique of claim 35.

42. A computer-readable medium having computer-executable instructions for performing the method of claim 36.
